(19) United States
(12) Patent Application Publication
(10) Pub. No.: US 2026/0031703 A1
(43) Pub. Date: Jan. 29, 2026

(54) APPARATUSES AND METHODS FOR CONTROLLED WAVESHAPING

(71) Applicant: Advanced Energy Industries, Inc., Denver, CO (US)

(72) Inventors: Luke Christopher RAYMOND, Redwood City, CA (US); Anas AL BASTAMI, Oakville (CA); Tony Hanlin SHI, Redwood City, CA (US); Johan Oscar Lennart ANDREASSON, Redwood City, CA (US); Wei LIANG, San Jose, CA (US)

(21) Appl. No.: 19/296,816

(22) Filed: Aug. 11, 2025

Related U.S. Application Data
(63) Continuation-in-part of application No. PCT/US2024/041824, filed on Aug. 9, 2024.
(60) Provisional application No. 63/518,883, filed on Aug. 11, 2023.
(60) Provisional application No. 63/682,262, filed on Aug. 12, 2024.
(60) Provisional application No. 63/682,241, filed on Aug. 12, 2024.

(51) Int. Cl. H02M 1/00; H02M 3/00; H02M 3/335

(52) U.S. Cl. CPC H02M 1/0058; H02M 1/0043; H02M 3/01; H02M 3/33584

(57) ABSTRACT

System for generating customized waveforms include a plurality of DC-DC converter cells coupled in series to form a stack; and a controller to generate control signals to drive the DC-DC converter cells in the stack to generate a customized waveform at a node, the controller comprising a lookup table to store at least one characteristic affecting the customized waveform, wherein the control signals to each of the plurality of DC-DC converter cells are based at least in part on the at least one characteristic.

### PRIORITY

This application claims priority to and the benefit of U.S. provisional patent application 63/682,262, filed on Aug. 12, 2024, for CONTROLLED WAVESHAPING METHODS AND APPARATUSES. This application also claims priority to and the benefit of U.S. provisional patent application 63/682,241, filed on Aug. 12, 2024, for MULTI-LEVEL BIDIRECTIONAL HIGH VOLTAGE WAVESHAPER. This application is also a continuation-in-part of international application PCT/US24/41824, filed on Aug. 9, 2024, for APPARATUSES AND METHODS FOR CONTROLLED WAVESHAPING, which claims priority to and the benefit of U.S. provisional application 63/518,883, filed on Aug. 11, 2023, for APPARATUS AND METHOD FOR NANOSECOND PULSING AND HIGH-VOLTAGE ARBITRARY WAVESHAPING. All aforementioned applications are hereby incorporated by reference herein for all that is disclosed.

### TECHNICAL FIELD

Aspects of the present disclosure are related generally to the field of power conversion for delivering power at relatively high voltages to loads.

### BACKGROUND

Many technologies require specialized high voltage waveforms to operate machinery and fabricate products. These technologies include semiconductor etching and deposition processes, solar wafer manufacturing, cardiac ablation, pasteurization, and other technologies. Therefore, a need exists for power supplies and methods that generate high voltage customized waveforms.

### BRIEF DESCRIPTION OF FIGURES

Various example embodiments, including experimental examples, may be more completely understood in consideration of the following detailed description in connection with the accompanying drawings, each in accordance with the present disclosure, in which:

FIG. 1 illustrates a block diagram of a system including a control stage and a power stage including DC-DC converter cells forming multiple stacks that may be controlled individually to generate customized high voltage waveforms.

FIG. 2 is an example schematic diagram of circuitry for implementing at least a portion of a DC-DC converter cell of FIG. 1 with the controller of FIG. 1 driving the DC-DC converter cell by using gate-control signals to engage an inverter.

FIGS. 3 and 4 are graphs showing examples of gate signals, drain voltages, and the output voltage V_{CELL} of the circuitry of FIG. 2.

FIGS. 5A-5D are a plurality of schematic diagrams of example implementations of switching stages that may be used in the switching stages of FIG. 1, wherein FIG. 5A is an example implementation using a pull-up switch that may be used to achieve fast output voltage charging across a load, FIG. 5B is an example implementation of a switching stage using a pull-down switch that may be used to achieve fast output voltage discharging within a series stack and/or across a load, FIG. 5C is an example implementation of the switching stage using a half-bridge structure with both a pull-up switch and a pull-down switch that may be used to achieve fast output voltage charging or discharging within a series stack and/or across a load, and FIG. 5D is an example implementation of a switching stage using a full-bridge structure with pull-up switches and pull-down switches that may be used to achieve both fast output voltage charging or discharging, as well as voltage polarity within a series stack and/or across a load.

FIG. 6 is a flow diagram illustrating a method of controlling the system of FIG. 1 to achieve a desired or customized output voltage and/or current waveform.

FIG. 7 is a plot illustrating an example in which current-voltage space of the output of the system of FIG. 1 is divided into regions or zones.

FIG. 8 is a plot illustrating an example in which the current-voltage space of the system of FIG. 1 is divided into regions or zones that are not necessarily rectangular.

FIG. 9 is a flow diagram illustrating a method of controlling the system of FIG. 1 by enabling or activating DC-DC converter cells based on the operating zone in the current-voltage space in feedforward mode and using closed-loop feedback to adjust frequency, duty cycle, and phase-shift to arrive at a desired output voltage or waveform.

FIG. 10 is a flow diagram illustrating a method of controlling the system of FIG. 1 using at least a frequency-controlled loop.

FIG. 11 is a flow diagram illustrating another method of controlling the system of FIG. 1 with closed loop feedback.

FIG. 12 is a flow diagram illustrating a method for controlling the system of FIG. 1 wherein a desired pulse is repeated in time.

FIG. 13A is a schematic diagram of an example load with a substantially capacitive component that can be driven using the system of FIG. 1, wherein the load may be a model of a processing chamber for processing semiconductor wafers.

FIG. 13B is another schematic diagram of another example load with a substantially capacitive component that can be driven using the system of FIG. 1, wherein the load may be a model of a processing chamber for processing semiconductor wafers.

FIG. 14 is a plot of example output voltages of an embodiment of the system of FIG. 1, wherein the output voltages are pulses having different widths as a function of time.

FIG. 15 is a plot of example output voltages of an embodiment of the system of FIG. 1, wherein the output voltages are pulses having different slopes as a function of time, and wherein the plot demonstrates an example of the capability of the system to generate high-voltage pulse waveforms with nanosecond rise and fall times, and with adjustable slopes during the fall time.

FIG. 16 is a plot of example output voltages of the system of FIG. 1 as a function of time, wherein the plot demonstrates an example of the capability of the system to generate high-voltage pulse waveforms with nanosecond rise and fall times, and with adjustable inflection points (the starting points of the controlled-slope duration of the waveform).

FIG. 17 is a plot of various example output voltages of the system of FIG. 1 as a function of time, wherein the plot demonstrates the effect of changing the total number of DC-DC converter cells (e.g., by adding more series-stacks coupled in parallel) on the overall waveform shape of an example pulse of the output. In the example of FIG. 17, sixteen DC-DC converter cells may be series-stacked, and a number of these stacks may be coupled in paralleled to obtain the desired total number of DC-DC converter cells.

FIG. 18 is a plot of various example output voltages of the system of FIG. 1 as a function of time; the plot demonstrates the effect of changing the total number of DC-DC converter cells (e.g., by adding more series-stacks in parallel) on the achievable rise times of an example pulse of the system. The plots zooms in around the vicinity of the rising edges for additional clarity. In this example, 17 DC-DC converter cells may be series-stacked, and a number of these stacks may be coupled in paralleled to obtain the desired total number of DC-DC converter cells 110.

FIG. 19 is a plot of various example output voltages of the system of FIG. 1 as a function of time; the plot demonstrates the effect of changing the total number of DC-DC converter cells (e.g., by adding more series-stacks that may be coupled in parallel) on the achievable fall times of an example pulse. The plot zooms in around the vicinity of the falling edges for additional clarity. In this example, sixteen DC-DC converter cells were series-stacked, and a number of these stacks were coupled in paralleled to achieve the desired total number of DC-DC converter cells.

FIG. 20 is a plot of rise time, fall time, and estimated bill-of-materials (BOM) cost of the power stage in the system of FIG. 1 as a function of the total number of DC-DC converter cells used. In the example of FIG. 20, sixteen cells were series-stacked, and a number of these stacks were coupled in parallel to achieve the total number of DC-DC converter cells shown on the x-axis.

FIG. 21 is a block diagram of an embodiment of the controller of FIG. 1 sending control signals to selectively engage certain DC-DC converter cells in and among a stacked arrangement of DC-DC converter cells to control voltage, such as overshoot, in the output of the DC-DC converter cells and the system of FIG. 1.

FIGS. 22A, 22B and 22C are block diagrams showing alternative configurations for providing power to stacked arrangements of DC-DC converter cells, with FIG. 22A having input signals to the DC-DC converter cells referenced commonly to a single pair of power rails, and FIG. 22B and FIG. 22C having different configurations, each with input signals to certain ones of the DC-DC converter cells referenced to different sets of power rails.

FIG. 23A and FIG. 23B are diagrams showing respective cross-sectional views for corresponding planar transformers, either of which is applicable to a transformer-based implementation of one or more of the DC-DC converter cells shown in FIG. 1 and/or FIG. 2, wherein FIG. 23A illustrates vias dispersed throughout planar windings (e.g., improving thermal issues) on different layers, and FIG. 23B illustrates conventional planar windings.

FIG. 24 is an exploded view of a PCB planar transformer which may be used with one or more of the DC-DC converter cells shown in FIG. 2 for the system of FIG. 1.

FIGS. 25A-C show scope shots illustrating adjustability of rise or fall time slopes between consecutive pulses by timing the turn-on and turn-off of the DC-DC converter cells of FIG. 1 in a prescribed sequence.

FIGS. 25D-E show scope shots illustrating adjustability of pulse peak voltage levels by timing the turn-on and turn-off of the DC-DC converter cells of FIG. 1 in a prescribed sequence to obtain customized voltage waveforms.

FIGS. 25F-G show scope shots depicting example pulse fall time adjustments of the output voltage of the system of FIG. 1 by ramping the operating frequency of the DC-DC converter cells.

FIG. 25H shows a scope shot illustrating the use of frequency stepping on the DC-DC converter cells of FIG. 1 to generate smooth voltage level adjustments within a pulse of the output voltage.

FIGS. 251-J show scope shots illustrating the use of frequency adjustment within a pulse of the output voltage of the system 100 of FIG. 1 to correct for input voltage rail variation effects using a feedforward configuration.

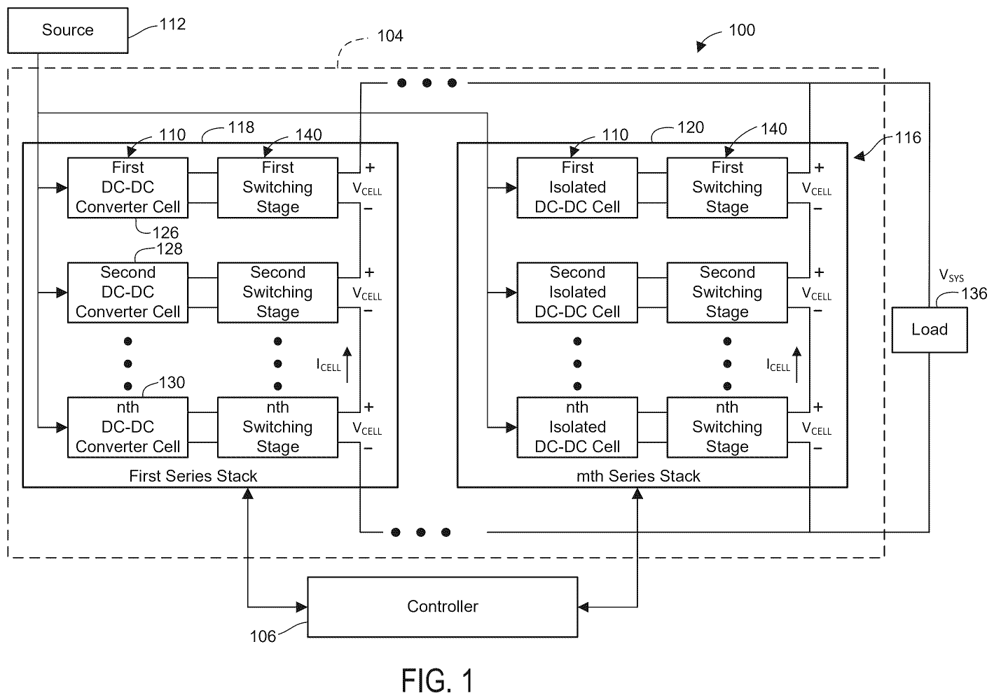

FIG. 26 illustrates a block diagram of an embodiment of the system of FIG. 1.

FIG. 27 illustrates an embodiment of the system of FIG. 1 configured to receive an analog reference signal.

FIG. 28 illustrates an embodiment of the system of FIG. 27 with the analog circuitry replaced with an analog-to-digital converter.

FIGS. 29A-29D illustrate example output voltages (e.g., V_{SYS}) that may be generated by the embodiments of the system of FIGS. 27 and 28.

FIG. 30 illustrates an embodiment of the system of FIG. 27, wherein a reference signal may have its signal parameters pre-stored in a memory device.

FIG. 31 illustrates another embodiment of the system of FIG. 1 including an alternate embodiment of the power stage.

FIG. 32A illustrates an embodiment of an output voltage of the system of FIG. 1 used to power devices for semiconductor fabrication.

FIG. 32B illustrates an embodiment of an output current of the system of FIG. 1 used to power devices for semiconductor fabrication.

FIG. 32C illustrates an embodiment of a voltage waveform generated by the system of FIG. 1 on a semiconductor wafer during semiconductor fabrication in response to the voltage of FIG. 32A applied to a processing chamber containing the semiconductor wafer.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” or “embodiment” as used throughout this application is only by way of illustration, and not limitation.

### DETAILED DESCRIPTION

Aspects of the present disclosure are applicable to a variety of different types of apparatuses, systems, and methods involving devices characterized at least in part by generating nanosecond-scale high-voltage pulses having customized waveform shapes (e.g., including closely around the vicinity of one or more peaks and/or fast rise and fall times). Aspects of the present disclosure have been found to be particularly beneficial for delivering power to equipment used in plasma processing in the semiconductor manufacturing industry. While the present disclosure is not necessarily limited to such aspects and/or specifically in the field of plasma processing, an understanding of specific examples in the following description may be understood from discussion in such specific contexts.

Some aspects of the present disclosure are related to power supplies or DC-DC converters and/or power conversion methods and circuit-based apparatuses involving use of logic circuitry to selectively engage (e.g., activating and/or deactivating) a plurality of resonant-isolated DC-DC converter cells. The selective engagement of respective ones of the DC-DC converter cells is to effect a combining of output signals from the individual DC-DC converter cells to generate an aggregate (e.g., high-voltage) output signal having a waveform shape that is customized based on the selective engagement.

In a more specific example, due to the inherent fast response of the DC-DC converter cells, nanosecond level pulsing and customized high voltage waveshaping may be achieved by controlling the timing of turning on or off the DC-DC converter cells and the voltage of each DC-DC converter cell. In certain specific example embodiments the selective engagement includes operating at least a subset of the DC-DC converter cells via a frequency set of one or more sufficiently-high switching frequencies in a range of frequencies (e.g., from about 1 MHz to 100 MHz) over at least several cycles of the frequency set to manipulate the waveform shape in a fractional portion (e.g., in individual portions corresponding to a small percentage of a full cycle, such as significantly less than a quarter or an eighth) of the output signal at the output terminal of the DC-DC converter cells.

According to other examples, some aspects of the present disclosure include methods and/or devices configured to produce accurately controlled pulsed voltage waveforms having unique or customized characteristics. These devices and methods may be incorporated into applications where this is a need for such waveforms. These characteristics may include waveforms of pulsed nature involving rise and fall times in the nanosecond timescale, with high voltages in the tens of kilovolts, and with the ability to control other voltage waveform features such as slope, pulse width, and pulse repetition rates.

In plasma processing applications, for example, plasma etching provides the advantage of anisotropic etching due to energetic ion bombardment of a substrate, making it conducive for etching small and high aspect ratio features in substrate (wafer) processing. In some plasma etching systems, a sinusoidal bias voltage supply is used to control the ion energy. Because of the time-varying nature of a sinusoidal waveform, ion fluxes impinging on a substrate typically have bimodal and wide ion energy distribution functions (IEDF). This is not optimal when smaller and higher aspect ratio etching features are required for advanced semiconductor technology, which require very narrow IEDF. A tailored or customized bias voltage waveform with a positive short pulse followed by a negative linear ramp (see FIG. 32A) can provide narrower ion energy distributions compared to the conventional sinusoidal waveform. Depending on specific types of plasma etching applications, the optimal maximum pulse voltage may be >10 kilovolts with a rise time of <100 nanoseconds, and a negative linear ramp lasting several microseconds. In some embodiments, the plasma etching tool may have the capability of adjusting the voltage levels, pulse widths, and negative ramp times to accommodate a wide range of etching recipes. For these reasons, having a pulse generation system with such capability enables accurate control over the shape of the IEDF at the surface of a substrate, thereby permitting precise control of the features on that substrate.

Another aspect in the operation of a the system 100 (FIG. 1) configured as a pulse generator, according to the present disclosure, is its ability to: (a) generate the required high voltages; (b) rapidly adjust the output voltage level V_{SYS} from very low/high voltages to very high/low voltages; and/or (c) modify the output voltage level with time precisely according to a prescribed pattern, such as a ramp waveform, a sawtooth waveform, a triangle waveform, and/or other waveforms.

Various examples/embodiments presented by the present disclosure are directed to issues such as those addressed above and/or others which may become apparent from the following disclosure. For example, some of these disclosed aspects are directed to methods and/or devices that use or leverage voltage and/or current from a stacked arrangement of resonant-isolated DC-DC converter cells (sometimes referred to herein simply as “converter cells”) having respective output terminals cooperatively configured to combine, at an output terminal, output signals respectively produced by individual DC-DC converter cells to produce an aggregate output signal V_{SYS} and through their control at high-precision (e.g., nanosecond timings), generating a customized waveform shape in the aggregate output signal.

In certain specific examples involving methods and/or apparatuses, aspects of the present disclosure involve a plurality of isolated DC-DC converter cells or resonant-isolated DC-DC converter cells and logic circuitry to control the DC-DC converter cells. The DC-DC converter cells may have respective output terminals cooperatively configured to combine, at an output terminal, output signals respectively produced by the DC-DC converter cells. The logic circuitry (e.g., programmable or fixed logic circuitry such as programmable logic devices (PLDS) or microcomputer circuitry) may control the DC-DC converter cells by selectively engaging (e.g., activating and/or deactivating), respective ones of the DC-DC converter cells to generate an output signal having a waveform shape that is customized based on such selective engagement.

In related methods according to the present-disclosure, specific implementations include selective engagement (including at least one of activating and deactivating), via logic circuitry, of respective ones of a plurality of isolated DC-DC converter cells or resonant-isolated DC-DC converter cells, and combining output signals from respective output terminals of the converter cells to generate an output signal having a waveform shape that is customized based on the selective engagement.

More specific example aspects, according to the present disclosure, may build on the above example methods and/or apparatuses. In one such example aspect, a set of time-coordinated gate drive signals may be provided or generated to control input ports of the DC-DC converter cells, including setting or adjusting timing and signal level of each of the time-coordinated gate drive signals for the selective engagement to adjust each respective output voltage generated by each of the DC-DC converter cells. The step of combining output signals may be in response to the selective engagement. Consistent with other such example aspects, the logic circuitry may affect the activation and deactivation via input signals provided to the DC-DC converter cells by controlled timings on an order of nanoseconds. The input signals may be used in affecting the activation and deactivation of the DC-DC converter cells and by respective voltages of each of the DC-DC converter cells, wherein altering the timings of the input signals may cause one or more changes in the waveform shape. Further, in yet other example aspects, the waveform shape may be controlled according to timing control (e.g., with precision on the order of nanoseconds or tens of nanoseconds) for which activation of one or more of the DC-DC converter cells may be delayed to realize a desired form of the waveform shape.

In certain other examples that may also build on the above-discussed aspects, methods and apparatus are directed to controlling generation of the waveform shape, via the selective activation and deactivation, to realize design specifications including one or a combination of two or more of the following: (a) fast and/or fall times on the order of nanoseconds; (b) high peak voltages on the order of kV; and (c) the waveform shape being controllable by at least one of a voltage ramp up at constant controllable slopes or voltage ramp down at constant controllable slopes.

Other example aspects may also build on the above-discussed aspects. One such aspect is the activation and/or deactivation of the DC-DC converter cells being controlled by the logic circuitry based on stored or configured waveform information. The stored information may be useful to realize the shape of a desired pulse waveform and its characteristics, wherein the stored or configured information may be provided by at least one of: storage settings; configured logic circuitry; and feedback signals obtained or determined during operation of the apparatus. Another such aspect may involve the DC-DC converter cells and the logic circuitry being cooperatively configured and selectively engaged to generate a pulsed waveform having a tailored bias voltage. An example of such a pulse may include a positive short pulse followed by a negative linear ramp. In some examples, the tailored or customized pulsed voltage waveform may be provided to a load in semiconductor processing to result in a desired narrow ion energy distribution in a plasma chamber. In this context, the pulsed voltage waveform may be characterized, for example, by a maximum pulse voltage, rise and/or fall times, and/or voltage and/or current ramps. According to some embodiments of the present disclosure, customized pulsed voltage waveforms may be generated with maximum pulse voltages in a range from several kV up to a several 10 kV, rise times in a range of 10 nanoseconds (ns) up to 100 ns, and negative linear ramps lasting up to several microseconds (psec).

Yet other example aspects, which may also build on the above-discussed aspects, may include inverter circuitry and isolation circuitry, including transformers, in one or more of the DC-DC converter cells. The inverter circuitry may include control gates for which respective gate-control signals are generated by a controller. The output of an inverter may connect to the primary side of a transformer. The secondary side of the transformer may couple to a rectifier stage. The combination of the inverter stage, transformer stage, and rectifier stage may constitute a single DC-DC converter cell. The logic circuitry may control generation of the waveform signal for respective ones of the DC-DC converter cells by at least one of increasing or decreasing, relative to steady state, a frequency of the gate-control signals or pulse widths of the gate-control signals to drive the inverter circuitry.

Other example aspects involve mitigation or elimination of signal overshoot in the output signal V_{SYS} at the output terminal of the DC-DC converter cells. One or more of the DC-DC converter cells may include inverter circuitry having control gates to receive respective gate-control signals. The logic circuitry may generate the waveform shapes by producing the respective gate-control signals at an initial higher switching frequency for operating the DC-DC converter cells (relative to a frequency used in steady state operation) to mitigate or eliminate such signal overshoot in the output signal at the output terminal. In a related aspect, the mitigation or elimination of the overshoot may be realized by starting the switching frequency of the gate signals of the inverter at a relatively high frequency and then reducing this frequency to reduce overshoot. In some embodiments, the frequency may be reduced without thereafter further adjusting one or more switching frequencies used to operate the DC-DC converter cells. In some examples (standing alone or in combination with the above related aspects), the proper timing and/or sequencing of the gate signals across different DC-DC converter cells may also be used to reduce overshoot of the combined output voltage signal V_{SYS}.

Another example aspect according to the present disclosure may use a stack of the converter cells with multiple DC rails isolated from one another by one or more voltage-isolation barriers to provide operating power at different voltage levels to respective ones of the DC-DC converter cells. The DC-DC converter cells may have respective input ports referenced to the different voltage levels.

In further examples related to the methods and devices, one or more of the DC-DC converter cells may include an inversion stage, an isolation stage, and a rectification stage. Design choices for inversion and rectification stages include the topology of the DC-DC converter cell, selection of active power devices with appropriate voltage and current ratings, and the tuning of component values. Example circuits for the inversion stage may include circuits having resonant switched-mode push-pull topologies, which can enable adjustment of output voltage by phase-shifting constituent inverters.

In yet further examples, the present disclosure is directed to systems and methods for generating nanosecond-scale high-voltage pulses having customized (sometimes referred to as arbitrary) and controlled waveform shapes, fast rise and/or fall times, and in some examples, an inherently small volume and mass. In related example embodiments, customized and controllable high output voltages may be produced by stacking the outputs of a group of highly miniaturized, optimized, and isolated individual resonant DC-DC converter cells in series and connecting the resulting stacked output across a load. The output voltage V_{SYS} can be implemented in various ways, such as the sum of the individual output voltages of each DC-DC converter cell or as an aggregation of certain (or all) the individual output voltages of each DC-DC converter cell as may be derived for different purposes (e.g., realizing a capped voltage and/or current level). The input of the DC-DC converter cells may be a DC voltage rail that may be provided by a front-end AC/DC converter, another DC-DC converter, or some other source of DC voltage.

In some example system-type embodiments, the present disclosure may be directed to a system including a load with a plurality of DC-DC converter cells (e.g., each as exemplified herein as including inverter, isolation and rectifier stages) configured with their respective outputs being combined at an output terminal. Logic circuitry or a controller may control the DC-DC converter cells by selectively engaging respective ones of the DC-DC converter cells to generate an output signal V_{SYS} that has a waveform shape which may be customized for a load according to such selective engagement via control signals used to drive gates of transistors (e.g., FETs) of the inverter stage.

In some examples, the present disclosure may be directed to apparatuses and methods involving control of a system (e.g., as described herein) by implementing a feedforward mode and/or a feedback mode for controlling the respective outputs of the DC-DC converter cells. The feedback mode may be implemented by monitoring levels at outputs of the DC-DC converter cells for finely adjusting the operations of the DC-DC converter cells. For example, such systems may be used to selectively engage DC-DC converter cells based on operating zones in a current-voltage space in a feedforward mode, and with the system then using closed-loop feedback to adjust frequency, duty cycle, and/or phase-shift to arrive at a desired output voltage. In other example embodiments, the feedforward mode and/or the feedback mode may be realized in various ways including, for example, via the circuitry of FIG. 1 implemented as threshold-level comparators, power-related parameter (e.g., voltage and/or current) measurement circuits to monitor the outputs of the DC-DC converter cells and/or the aggregated or combined output in combination with data pre-stored in a look-up table or by algorithm-executing data-processing computing circuitry to assess current and/or past measurements to learn and/or predict what parameters to set for the DC-DC converter cells (and which or how many of the converter cells to engage) for ensuing signal generation in an initial course mode and/or for subsequent fine tuning.

In some example embodiments, multiple DC-DC converter stacks may be coupled in parallel to provide higher current levels to a load. Each stack may be optimized to supply up to a predetermined amount of current at high efficiency. For a specified output current requirement, stacks can be added in parallel as needed to meet the load requirements, with each stack providing up to its rated current. In some example circuits according to the present disclosure, the stacks may be substantially identical such that current is shared substantially equally among the stacks to avoid efficiency degradation, overloading, and/or overheating.

In some embodiments, multiple DC-DC converter cells may be connected in series or parallel to achieve fast transient response for the output waveform. In some embodiments, the DC-DC converter cells may be configured to have substantially identical characteristics, including output voltage/power, switching frequency, transient response, and/or voltage isolation requirements. In other embodiments, the DC-DC converter cells can be designed differently within a stack to have different output voltages/power, different switching frequencies, different transient responses, and/or different voltage isolation requirements, etc. Furthermore, due to the isolated nature of the DC-DC converter cells in the type of system shown in FIG. 1, each DC-DC converter cell can be connected to provide a voltage waveform that can be positive or negative with respect to a reference node in the system. The controller may include logic circuitry configured to retrieve data from external circuitry such as databases stored in a memory circuit, which may include the above-disclosed look-up table and/or configuration parameters for executing the above-disclosed algorithm.

The converter cells in example embodiments of the present disclosure may be tuned to realize soft switching (e.g., zero-voltage switching) of the active power devices to minimize switching losses and maintain high efficiency. The DC-DC converter cells may be able to leverage high switching frequency (in different examples, from 1 s to 10 s of MHz, from 10 s to 100 s of MHz, and in ranges that extend below and beyond such ranges) of the power devices. This may significantly reduce the size requirements for the internal energy storage devices, including capacitors, inductors, and transformers. The switching frequency of the DC-DC converter cells can furthermore be adjusted to meet specific rise and/or fall time targets, or to adjust the output voltages of the DC-DC converter cells.

The DC-DC converter cells can be configured to process bidirectional energy flow such that energy stored in the output can be recycled back to the input when driving capacitive loads. In some embodiments, the system output waveforms can be configured as unipolar, and in other embodiments, the system output waveforms can be configured as bipolar. When driving capacitive loads, bipolar pulses centered at zero may require half of the energy compared to unipolar pulses to achieve the same peak-to-peak voltage across the capacitive load.

In some embodiments, a DC rail providing the inputs to the DC-DC converter cells may be at a fixed DC voltage that is common to all the DC-DC converter cells. In other embodiments, the voltage of the input voltage rail may be an adjustable DC voltage that is common to all DC-DC converter cells. In other embodiments, the input voltage rail to each DC-DC converter cell may be distinct from that of other DC-DC converter cells and may be fixed or adjustable.

In some embodiments, selective engagement of the DC-DC converter cells may involve selectively activating, selectively deactivating, and/or selectively setting or adjusting timing and coordination of the DC-DC converter cells by way of the gate control signals driving the inverters. With such selectively activating and/or deactivating, each DC-DC converter cell can be optionally turned on or off, and can be used as part of one example approach for coarsely varying the output voltage level in discrete steps. For a given required output voltage, the higher the number of DC-DC converter cells stacked in series, the smaller the discrete steps can be, and the less need there may be for finer output voltage control. An advantage of on/off control in this context is the ability of the pulse generation system to step from low voltage levels (e.g., 10 s of volts) to much higher voltage levels (e.g., 10 s of kilovolts), or vice versa, at very fast time scales (e.g., 10 s of ns) than would otherwise be possible with other approaches for output voltage control. Furthermore, the individual on and/or off (sometimes referred to as, “on/off”) control of each DC-DC converter cell in a given group of series-stacked DC-DC converter cells can also be timed such that one or more DC-DC converter cells are delayed with respect to the other DC-DC converter cells to realize a desired output voltage waveform shape.

In some examples, multiple converter cells can be turned on or off in a controlled sequence during a control set point change to minimize output waveform overshoot or undershoot. The set point is the point at which the electrical circuit or converter cell is activated or de-activated. Such multiple converter cells can also operate at a synchronous switching frequency but having different phases to achieve output ripple cancellation.

In some embodiments, the DC-DC converter cells may include push-pull resonant power inverter stages, wherein adjustment of output voltage of one or more DC-DC converter cells may be achieved by phase shifting two push-pull branches within the inverter stage. In some example circuits according to the present disclosure, the range over which phase shifting may be utilized is limited to providing only small adjustments in output voltage so that the DC-DC conversion efficiency is not impacted.

In some embodiments, additional switching stages such as a half-bridge, a full-bridge, a pull-down switch, or a pull-up switch can be cascaded after the output of one or more of the individual DC-DC converter cells 110 to further improve the transient response (e.g., rise time, fall time, etc.) of the output waveform.

Example embodiments of the present disclosure may include a measurement and controls module that may (a) relay signals from various sensors within the system, such as output voltage, output current, individual stack current, to name a few; (b) process the received signals; and (c) providing appropriate commands to the converter cells and the output switching stages. The control module may also contain information on the shape of the desired pulse waveform and its characteristics.

In some embodiments, a method for controlling the system includes receiving output voltage and corresponding output current set points, identifying an operating region or “zone” within the current-voltage space, and adjusting the converter cell configurations according to a preassigned configuration for each region. Such configurations may include a number of enabled converter cells connected in series, a number of enabled cells connected in parallel, operating frequency, input voltage, duty cycle, and/or phase-shift within individual DC-DC cells. The preassigned configurations may be stored in appropriate memory locations within the system controller, such as using lookup tables, or other means.

In some embodiments, the set points may be provided to the system controller via analog voltage signals input to the system, via digital signals represented by a number of bits being transmitted to the controller, via serial communication including RS232, RS485, or other protocols, parallel communication, ethernet, universal asynchronous receiver-transmitter (UART), etc., or as values encoded in the form of pulse width modulation.

In some embodiments, once the converter cell configuration is determined based on the operating region within the current-voltage space, the system may transition to a closed-loop control mode, wherein the operating frequency, input voltage, or both, are dynamically adjusted to achieve a desired output voltage and/or current.

In other embodiments, once the converter cell configuration is determined based on the operating region within the current-voltage space, the operating frequency for the converter cells may be determined via a simple or adaptive feedforward scheme wherein the frequency may be selected based upon a preassigned frequency table. Such a table may include operating frequency or input voltage at various combinations of desired output voltages and corresponding current set points.

In some embodiments, a single frequency table may be preassigned for all regions within the current-voltage space. In other embodiments, a unique preassigned frequency table may be used for each region within the current-voltage operating space. The one or more frequency tables may be pre-populated during system characterization by manual entry, automated population via one or more scripts while training the system on a target load, or by other means.

In other embodiments, a method for controlling the system may include receiving output voltage and corresponding output current set points, determining the number of stacks to be enabled, dynamically incrementing or decrementing the number of DC-DC converter cells connected in series such that the measured output voltage is within a threshold of the desired output voltage, and dynamically adjusting the operating frequency, duty cycle, and/or phase-shift within individual converter cells.

In the above and/or other embodiments, the system may be operated to produce repetitive pulses. A method for controlling such a system may include initially, for a given pulse, selecting converter cell configurations, including at least operating region, frequency, duty cycle, among others, based on the last known configuration from the preceding pulse. The system may then transition to closed-loop mode wherein the operating frequency and region may be adjusted such that the output converges to the desired operating point.

In some embodiments, a method for controlling rise times, fall times, overshoot, or combinations thereof, of the output waveform may include frequency ramping, whereby the operating frequency may be smoothly adjusted to achieve a desired transient behavior. Further, some embodiments may utilize frequency stepping, such as within a pulse, to adjust the output voltage level smoothly. Some example embodiments of the present disclosure may be suitable for a range of applications, including plasma processing in semiconductor manufacturing. Some advanced plasma etching systems, for example, require a tailored bias voltage waveform with a positive short pulse followed by a negative linear ramp. This type of bias voltage waveform can provide narrower ion energy distributions (e.g., as may be compared to a more-conventional sinusoidal waveform), with maximum pulse voltages reaching 10 s of kV, rise times of <100 ns, and/or negative linear ramps lasting several μs. Certain specific example embodiments of the present disclosure may also provide the capability of adjusting the voltage levels, pulse widths, as well as ramp times, to accommodate a wide range of semiconductor etching recipes described above.

In yet further aspects which may be used alone and/or in combination with the above types of example power converters, some embodiments of the present disclosure are directed to a transformer core that may include: a primary winding and one or more secondary windings shaped to mitigate or minimize eddy current losses, and a multilayer printed circuit board (PCB) including a plurality of layers securing traces for the primary winding and a plurality of layers securing traces for the secondary winding. The transformer core may also include vias through certain of the traces to minimize winding losses and to facilitate thermal conductivity. The PCB, the primary winding and the secondary winding may be cooperatively stacked, vertically among certain of the plurality of layers of the PCB, to facilitate magnetic coupling between the primary winding and the secondary winding.

FIG. 1 is a block diagram of a type of system 100, according to examples of the present disclosure, for generating high-voltage customized waveforms as described herein. The system 100 may include two stages: a power stage 104 and a controller stage, sometimes referred to herein as a controller 106.

The power stage 104 may include a plurality of DC-DC converter cells 110 that may be isolated DC-DC converters arranged as a modular array of DC-DC converters that may be isolated. The DC-DC converter cells 110 in the array may receive input from a source 112, such as a DC voltage source, a front-end AC/DC converter, another DC-DC converter, or other sources. As described herein, the DC-DC converter cells 110 may serve as power building blocks to realize a desired output voltage V_{SYS} and current from the system 100. In some examples of the system 100, the DC-DC converter cells 110 may be substantially similar or identical to one another in terms of component and architecture. In other examples, the DC-DC converter cells 110 may be different from one another in these regards. For example, the DC-DC converter cells 110 may have different output voltages and/or currents, different switching frequencies, different transient responses, and/or different isolation requirements.

A plurality of the DC-DC converter cells 110 may be stacked in series to form a stack. In the example of FIG. 1, the system 100 includes a plurality of stacks 116, which are referred to individually as a first stack 118 and a second stack 120. The first stack 118 may include n DC-DC converter cells 110, wherein the number n is a design choice that may be a function at least of the desired voltage output of the system 100. The DC-DC converter cells 110 of the first stack 118 are referred to individually as the first DC-DC converter cell 126, the second DC-DC converter cell 128, and the nth DC-DC converter cell 130. In order to achieve higher voltages, the DC-DC converter cells 110 in each of the plurality of stacks 116 may be connected in series and may be isolated from one another.

Each of the DC-DC converter cells 110 may be configured to produce an output voltage V_{cell} and an output current I_{cell}; therefore, when n of the DC-DC converter cells 110 are connected in series, the resulting voltage produced across the series stack is nV_{cell}. Similarly, multiple stacks may be connected in parallel to provide a desired output current that is higher than the rated current of an individual stack. Specifically, when m converter stacks are connected in parallel, the resulting current provided to the load is ml_{cell}. These voltages and currents may change in examples wherein the DC-DC converter cells 110 do not output the same current and/or voltage. In this manner therefore, a suitable combination of m×n converters can be selected to meet a target load voltage, current, and/or rise time. In some examples, the plurality of stacks 116 may be configured such that they may share current equally among the plurality of stacks 116 as much as practicably possible. In certain other examples, the plurality of stacks 116 may not be substantially identical and the system 100 may still function correctly.

The controller 106 may selectively engage (e.g., activate) the individual ones of the DC-DC converter cells 110 to cause the outputs of the engaged DC-DC converter cells to be combined in series. This in-series arrangement may correspond to a series stack of certain ones of the DC-DC converter cells 110 such as, but not limited to, a series stack with a broad range of DC-DC converter cells 110 such as including 2-3 DC-DC converter cells 110 at a lower end and up to 30 or more DC-DC converter cells 110 at an upper end.

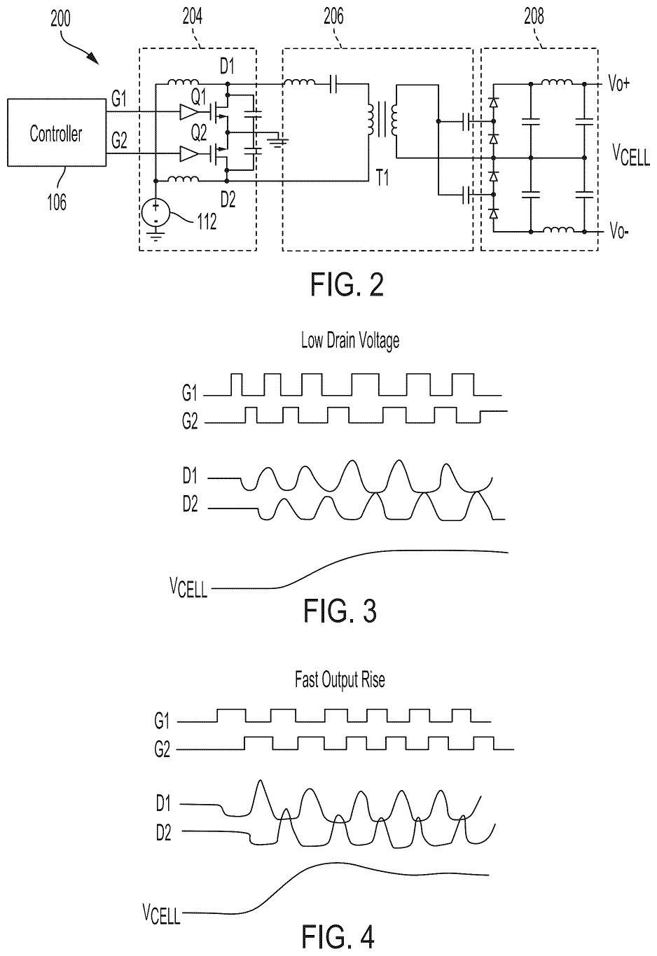

Additional reference is made to FIG. 2, which is a schematic diagram illustrating an embodiment of at least a portion of a circuit 200 within one or more of the DC-DC converter cells 110. The circuit 200 may include an inversion stage 204, an isolation stage 206, and a rectification stage 208. The controller 106 may output a first gate signal G1 to a gate of a first transistor Q1 and a second gate signal G2 to a gate of a second transistor Q2. In some examples, the transistors Q1 and Q2 may be field effect transistors (FETs) or other electronic switching devices.

In some examples, the inversion stage 204 may be based on a Class E design in which the drain node D1 of the first transistor Q1 and the drain node D2 of the second transistor Q2 are unclamped. In some examples, the controller 106 may be configured to generate the gate drive signals G1 and G2 to reduce an initial voltage spike on the drains D1 and D2. In some examples, reduction of an initial voltage spike is achieved by setting a width of a first gate pulse G1 to about half the value of a second gate pulse G2. About may be within 5-10%, 10-15%, and in some instances within 20-25% of the first gate pulse G1. In some examples of the circuit 200, there is no initial input inductor, current, or load current, so fewer volt-seconds are required to reach the steady state turn off condition. The same principle can be applied to adjust subsequent gate pulses to track transient inverter and load conditions.

In other examples, the controller 106 may be configured to control generation of the signals G1 and G2 by: generating the waveform signals at an initial lower frequency relative to steady state to realize faster rise times at the output of the inversion stage 204; producing the waveform signals G1 and G2 at an initial higher frequency relative to steady state to realize slower response and reduced overshoot at the output of the isolation stage 206; and/or by setting consecutive gate pulse widths of the waveform signals G1 and G2 with an initial gate pulse width that is substantially reduced relative to an ensuing gate pulse width.

Additional reference is made to FIGS. 3 and 4, which show examples of gate signals G1 and G2, drain voltages D1, and D2, and the output voltage V_{CELL}. The gate signals G1 and G2 may engage the isolation stage 206 to minimize drain voltages D1 and D2 during transients and/or to generate fast rise times in the output voltage V_{CELL}.

In some examples, the gate signals G1 and G2, can be generated and/or manipulated (e.g., adjusted) by the controller 106, as well as intervening circuitry or components (not shown) to affect one or more of the following aspects: the switching behavior, both in switch stresses and output performance (rise time, overshoot, etc.) in terms of operating frequencies, frequency modulation, and duty control. Some examples of the circuitry may be configured to operate where frequency has an inverse relationship with output voltage and current capability. The open loop rise time may at least partially depend on frequency, owing to the presence of tuned reactive elements in the circuit 200. In some aspects, faster rise times can be achieved by operating at lower frequencies during the initial rise. Likewise, slower response and reduced overshoot can be achieved by operating at higher initial frequencies.

According to another aspect of the circuit 200, the controller 106 may generate the gate drive signals G1 and G2 to control the signal transition timing (e.g., faster rise time) at the output voltage V_{CELL} of the circuit 200. In some embodiments, the duty cycle of gate drive signals G1 and G2 in such FET-based circuitry may be constrained by efficiency interests for a given operating frequency and load. However, where efficiency is not as important as rise time or other behavior, or for certain tunings and operating conditions, duty cycle can be varied to shape the output voltage V_{CELL}. In this case, the process may include increasing the duty cycle to force the inversion stage 204 to generate higher peak drain voltages (thus hard switching) or to overcome distortion from a low impedance load. The same timing diagrams may be used to represent the gate drive signals G1 and G2 and the corresponding drain voltages D1 and D2 for effecting a faster rise time at the output V_{CELL} of the converter cell.

Accordingly and in view of the above, some examples of the present disclosure include effecting lower drain voltages in examples using such an inverter such as the inversion stage 204 and controlling the transition time at the output of the circuit 200. In one such example, the circuit 200 may be one of among the DC-DC converter cells 110 (FIG. 1) having respective outputs connected in series to provide an aggregated output voltage based on output voltage contributions from respective outputs of selected ones of the DC-DC converter cells 110 activated to generate an output voltage. The DC-DC converter cells 110 may include the inversion stage 204, the isolation stage 206, and the rectification stage 208.

The inversion stage 204 may have gates to receive gate drive (control) signals G1 and G1 from the controller 106. The isolation stage 206 may include at least one transformer to pass output signals from the inversion stage 204 to the rectification stage 208. The rectification stage 208 may couple to an output terminal where activated ones of the DC-DC converter cells 110 effect respective contributions to provide a combined (or aggregated) output signal V_{SYS} (FIG. 1) of the system 100 (FIG. 1). The controller 106, in generating and/or controlling gate drive signals of the FETs Q1 and Q2 within the inversion stage 204, may control generation of gate drive (control) signals G1 and G2 for each of the selected ones of the DC-DC converter cells 110 to be activated by at least one of increasing or decreasing, relative to steady state: a frequency or pulse width of the gate drive (control) signals G1 and G2.

In other examples, which may be implemented alone or with the above aspects, the initial gate pulse width of G1 and G2 may be reduced by about one half, with a certain margin of error, of an ensuing gate pulse width of G1 and G2. In related examples wherein the inversion stage 204 has drain nodes D1 and D2 that may be unclamped, the controller 106 may be configured to control generation of the waveform signals G1 and G2 by setting consecutive gate pulse widths to mitigate or reduce an initial voltage spike on the drains D1 and D2.

Design choices for the inversion stage 204 and rectification stage 208 may include the topology of the circuit 200, selection of active power devices with appropriate voltage and current ratings, and the tuning of component values. Example circuits for the inversion stage 204 may include resonant switched-mode push-pull topologies, which can allow adjustment of the output voltage V_{CELL} by phase-shifting constituent inverters. These may include push-pull variants of resonant class D, class E, class F, or D2 topologies, among others. In certain applications, for optimal efficiency and mitigating losses, switched-mode designs utilizing zero-voltage switching (ZVS) of the active devices may be used. Additionally, in some examples, high-switching frequencies (e.g., 1 s to 10 s of MHz, or 1 s to 100 s of MHz and beyond) may be used to minimize energy storage, volume, and weight requirements. Non-push-pull switched-mode resonant variants may also be used if inverter phase-shifting within one or more of the DC-DC converter cells 110 need not be used for output voltage control. For rectification, similar resonant topologies may be used whereby the rectifying components may consist of semiconductor switches or diodes.

Power stage isolation in the isolation stage 206 between the inversion stage 204 and the rectification stage 208 may be achieved using a standalone transformer T1 with appropriate voltage standoff rating across the primary-to-secondary windings. In other examples, the transformer primary and secondary windings may be integrated into the inversion stage 204 and rectification stage 208, respectively. Adequate voltage isolation between the windings may be provided by controlling the spacing between primary and secondary windings as described herein, introducing one or more high-voltage standoff materials between windings (e.g., polyimide films, coatings, etc.), or both. As one of many examples in this context, reference may be made to U.S. Pat. No. 11,228,252, which discloses a planar-PCB transformer as an isolation stage between inverter circuitry and DC-DC rectifier circuitry, with FIGS. 1, 5A, 5B, 4A-4C, exemplifying a planar PCB transformer that provides the inductive isolation in one or more of the DC-DC converter cells 110.

The inversion stage 204 and rectification stage 208 may be designed to allow bidirectional flow of energy to and from a load 136 (FIG. 1) coupled to the system 100. This may be useful in cases such as when the load 136 consists of an energy storage element (e.g., when the load 136 is a substantially capacitive load). The power stage 104 can channel the stored energy back to the input by receiving appropriate control signals to reverse the energy flow. In applications requiring repeated charging and discharging of a capacitive load, for example, the energy that is redirected back to the input may prevent the energy from being lost and dissipated as heat, thereby improving efficiency of the system 100 and reducing the need for additional thermal management.

Referring again to FIG. 1, in some examples, the power stage 104 may include a plurality of switching stages 140 coupled to the outputs of the DC-DC converter cells 110. The switching stages 140 may be additional switching stages and may be or include half-bridges, full-bridges, pull-down switches, pull-up switches, for example. Each of the switching stages 140 may be rated up to the maximum expected voltage of the output of their respective DC-DC converter cell. In other examples, the system 100 may have a single or multiple switching stages connected across multiple ones of the DC-DC converter cells 110 or the output of the system 100 (i.e. across the load 136). Each of these switches may be rated up to the maximum expected voltage at their respective nodes.

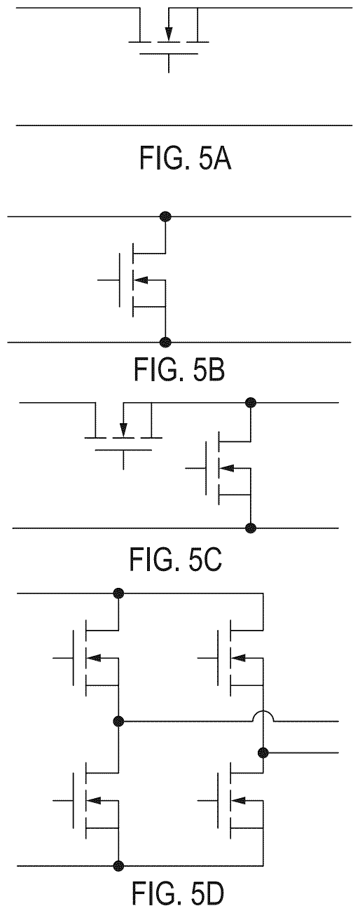

In these and other embodiments disclosed herein, the additional switching stages may be incorporated to further improve the rise time and/or fall time of the output waveform. FIGS. 5A-5D illustrate schematic diagrams of example embodiments of such switching stages, including the ability for achieving a voltage pull-up using a series semiconductor switch (FIG. 5A), a voltage pull-down using a shunt semiconductor switch (FIG. 5B), both pull-up as well as pull-down using a half-bridge arrangement of switches (FIG. 5C), and all of the above with the ability to swap output voltage polarities using a full-bridge arrangement (FIG. 5D). As one of many examples of a switching stage/supply in this context, reference may be made to U.S. Pat. No. 11,978,611 (e.g., passim and disclosing with FIG. 2 a switching-mode supply with a controller that generates drive-control signals to engage high-power (FET) switching components). It is to be understood that these are only example embodiments of the switching stage 140 and should not be regarded as limiting. Other implementations of the switching circuitries are possible, such as using multiple switches instead of a single switch, among other possibilities.

Due to the isolated nature of the DC-DC converter cells 110 in the system 100 shown in FIG. 1, the system 100 can be configured to provide an output voltage waveform V_{SYS} at a node, wherein the waveform may be positive or negative with respect to a reference node within the system 100. Therefore, the system 100 can also be configured to provide an output voltage waveform V_{SYS} that can be unipolar or bipolar. It is to be noted that when the system 100 is driving a capacitive load 136, bipolar pulses centered at zero may require half of the energy compared to unipolar pulses to achieve the same pulse voltage differentially across the capacitive load 136.

The controller 106 as shown in FIG. 1 may be configured to perform control objectives of the system 100 and ensure correct and safe operation of all parts of the system 100 including the power stage 104 as described with reference to FIGS. 2-4. In some embodiments, the controller 106 may obtain various measurements from the power stage 104 as appropriate, processes these measurements, and provides the necessary control signals (e.g. G1 and G2) to each of the DC-DC converter cells 110 in the power stage 104 to achieve the desired output waveform shape and voltage level.

The controller 106 may receive and/or generate measurement and control signals present at either side of the isolation barrier of the power stage 104. For these signals, various ways can be used for the signals to cross the isolation barrier. These include, but are not limited to, using galvanic isolation such as transformers, capacitive isolation, or optical isolation. Such schemes are applicable to both analog and digital measurement and control signals.

Various control methods may be suitable for the high-voltage customized pulse generation system 100 of FIG. 1. In various examples, multiple configurations of voltage, current, and/or power control may be implemented. Enabling and disabling the inversion stage 204 (FIG. 2) of individual DC-DC converter cells 110 may enable rapid changes in voltage, power, and/or current generation by the system 100. The configuration of the system 100 may include a plurality of stacks 116 having the DC-DC converter cells 110 coupled in series and/or parallel allows for relatively fine control of the output voltage V_{SYS} of the system 100 while allowing each of the individual DC-DC converter cells 110 to operate close to an optimal conversion efficiency. Enabling and disabling individual ones of the DC-DC converter cells 110 (e.g., sequentially and/or selectively) in this manner can be beneficial when relying on a variable input DC bus voltage as the source 112 which may have limited control bandwidth and/or transient response.

Frequency of the signals G1 and G2 (FIG. 2) can be used as a method of controlling the output volage V_{SYS} of the system 100 due to the resonant nature of some embodiments of the DC-DC converter cells 110. Changing the fundamental DC-DC conversion frequency can be used to adjust voltage, current, and/or power generated by the system 100. Frequency can also be adjusted to optimize transient response and achieve a desired wave shape when moving from one operating point to another. Frequency can be adjusted as a method of optimizing conversion efficiency or minimizing losses in various components within the power stage 104.

For inversion stages 204 (FIG. 2) using complimentary “push-pull” designs, the gating signals G1 and G2 of a single DC-DC converter cell, may operating at a relative phase of 180 degrees and can be phase shifted to control the amplitude of the voltage signal driving the rectification stage 208 of the circuit 200. This phase control can thus allow the voltage, current, and/or power contribution of individual inverters to be adjusted. In some examples, the range over which phase shifting the gating signals is utilized may be limited to providing only small adjustments (e.g., less than P %, where P is greater than 0 and less than 5, 10 or 15) in the output voltage V_{SYS} so that the DC-DC conversion efficiency is not adversely impacted. In some embodiments, the phase of one or more of the DC-DC converter cells 110 may be coordinated with respect to other DC-DC converter cells 110 to reduce or substantially cancel voltage and/or current ripple experienced by the load 136 and/or allow for reduced output filtering and better dynamic response.

Gating duty cycle of the signals G1 and G2 applied to the inversion stage 204 may be used to optimize cell conversion efficiency. Dynamic adjustment of the signals G1 and G2 during operating point changes can be used to adjust transient response.

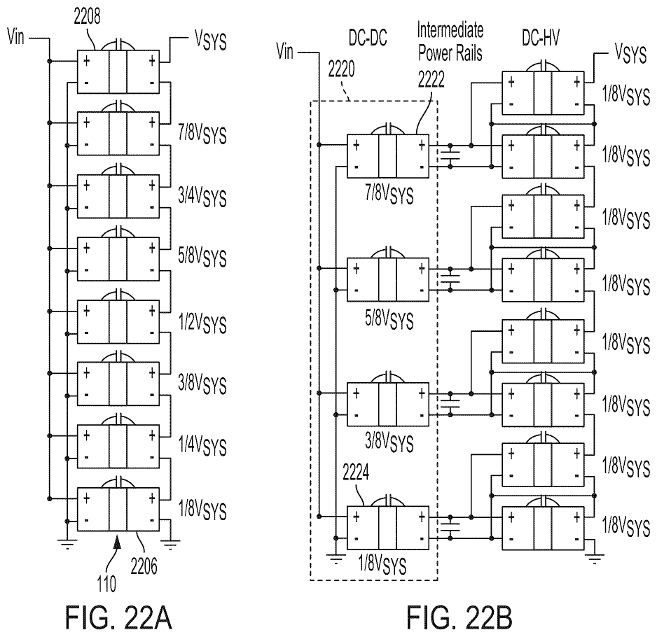

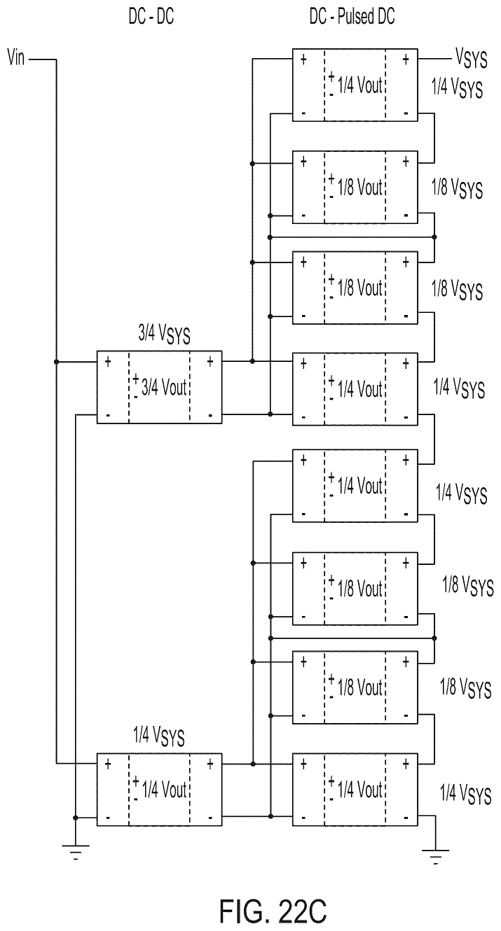

The input voltage from the source 112 to the DC-DC converter cells 110 can be adjusted to control the output voltage V_{SYS} of the system 100 by adjusting the voltages V_{CELL} of individual ones of the DC-DC converter cells 110 to achieve a specific voltage target or optimize performance of a specific operating point. While a single variable DC bus feeding all the DC-DC converter cells 110 may be implemented, sub-groups of the DC-DC converter cells 110, such as series and/or parallel strings, and even individual DC-DC converter cells 110 can have their own variable DC voltage rail to add tunability and flexibility to the system 100. Examples of this approach are disclosed in connection with FIGS. 22A-22C described herein.

Feedback from the output of the system 100 or other voltages generated by the system 100 can be used by the controller 106 to set output voltages V_{CELL} of individual ones of the DC-DC converter cells 110. The feedback can also be based on measured current and/or power, including derivatives of these signals and calculated load impedance. In examples where repeated or pulsed output signals are required, the system 100 can learn from previous pulse(s) and adjust for the next pulse by measuring and analyzing telemetry data at discrete times during a pulse. The control parameters can thus be adjusted by defining a trajectory in an adaptive feedforward scheme rather than simply as a result of pure feedback. In some embodiments, the system 100, such as the controller 106, can store these control parameters. Various sets of control parameters may be obtained by training the system 100 on a range of loads (e.g., load impedances) and stored in appropriate memory within the system 100, such as lookup tables (LUTs) or other configurations. Similarly, such control parameter sets may be transferred to system memory from an external device (e.g., a computer) based on prior knowledge and characterization of the system 100.

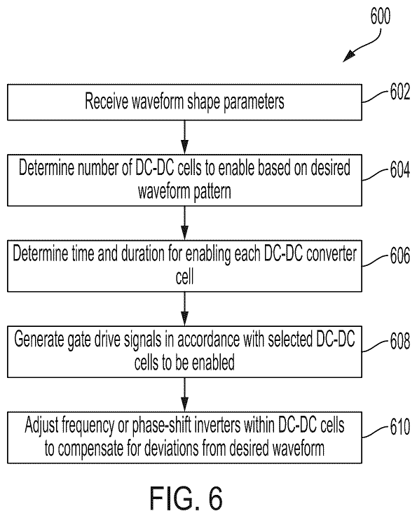

FIG. 6 depicts a flow diagram of an example method 600 for a control strategy as described above to achieve a desired output waveform from the system 100. The method 600 includes, in operational block 602, receiving waveform shape parameters. These parameters may be received via the source 112, stored in the controller 106, or received via other means as described herein. The method 600 includes, in operational block 604, determining the number of DC-DC converter cells 110 to enable based on the desired waveform. As described herein, the controller 106 may enable and disable individual ones of the DC-DC converter cells 110 to generate the desired waveform. The method 600 includes, in operational block 606, determining time and duration for enabling the DC-DC converter cells 110 to generate the desired waveform. It is noted that the DC-DC converter cells 110 may be engaged and disengaged during a period of a waveform. The method 600 includes, in operational block 608, generating gate drive signals in accordance with the selected DC-DC converter cells 110 that are to be enabled. The gate drive signals may be the signals G1 and G2 described with reference to FIG. 2. The method 600 includes, in operational block 610, adjusting frequency or phase shift of the drive signals to the inverters (e.g., the inversion stage 204, FIG. 2) within the DC-DC converter cells 110 to compensate for deviations from the desired waveform.

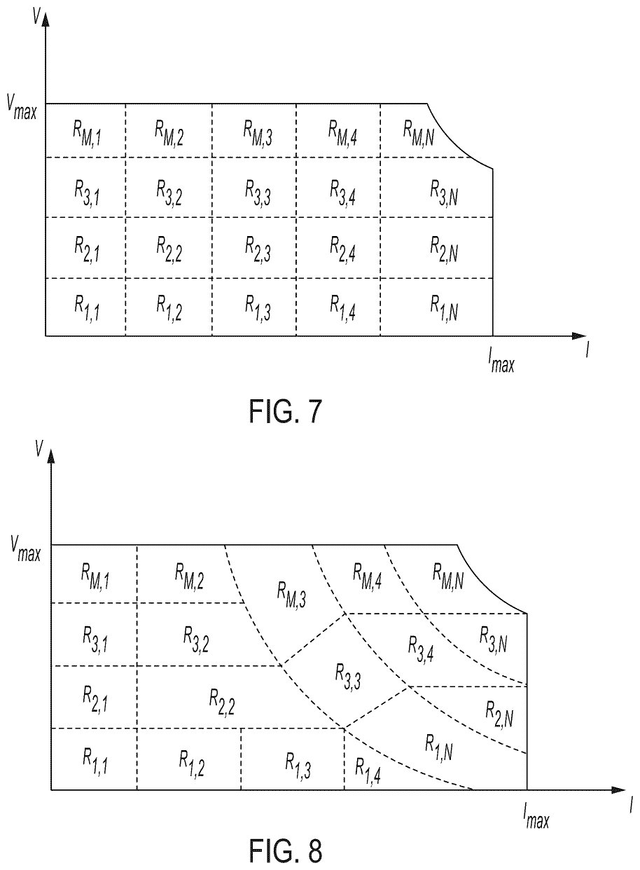

In some examples according to the present disclosure, the operating output voltage-current space of the system 100 may be divided into regions or zones as shown in FIGS. 7 and 8. In some embodiments, different sets of control parameters, such as number of DC-DC converter cells 110 to be enabled in series or parallel can be preassigned for each region. In certain example embodiments of the present disclosure, the operating current-voltage space may be divided into rectangular regions as shown in FIG. 7. Such division may, for example, allow for simple selection of a number of series or parallel DC-DC converter cells 110 to enable: if a higher voltage is desired for the same output current, more DC-DC converter cells 110 can be enabled in series; if a higher current is desired for the same output voltage, more DC-DC converter cells 110 can be enabled in parallel, as shown in Table 1, as provided below:

TABLE 1

| | Example DC-DC cell |
|---|---|
| Region | assignment |
| R_{1, 1} | 1 cell in series, 1 cell in parallel |
| R_{2, 1} | 2 cells in series, 1 cell in parallel |
| R_{3, 1} | 3 cells in series, 1 cell in parallel |
| R_{M, 1} | M cells in series, 1 cell in parallel |
| R_{1, 2} | 1 cell in series, 2 cell in parallel |
| R_{1, 3} | 1 cell in series, 3 cell in parallel |
| R_{1, N} | 1 cell in series, N cell in parallel |
| . | . |
| . | . |
| . | . |
| R_{m, N} | M cell in series, N cell in parallel |

While FIG. 7 shows such regions being rectangular, in other examples, the regions may not be necessarily rectangular as shown in FIG. 8. It may be desirable to assign the enabling of series or parallel DC-DC cells, for example, based on output voltage, current, power, efficiency, losses, or any combinations thereof, resulting in many possible shapes for the regions, including irregular shapes. The example of FIG. 8 shows a combination of rectangular (at low voltages/currents) and non-rectangular regions. In the examples, each region corresponds to an assignment of enabled series or parallel DC-DC converter cells 110 and may also correspond to other control parameter choices, including operating frequency, duty ratio, input voltage, or phase-shifts within the DC-DC converter cells 110.

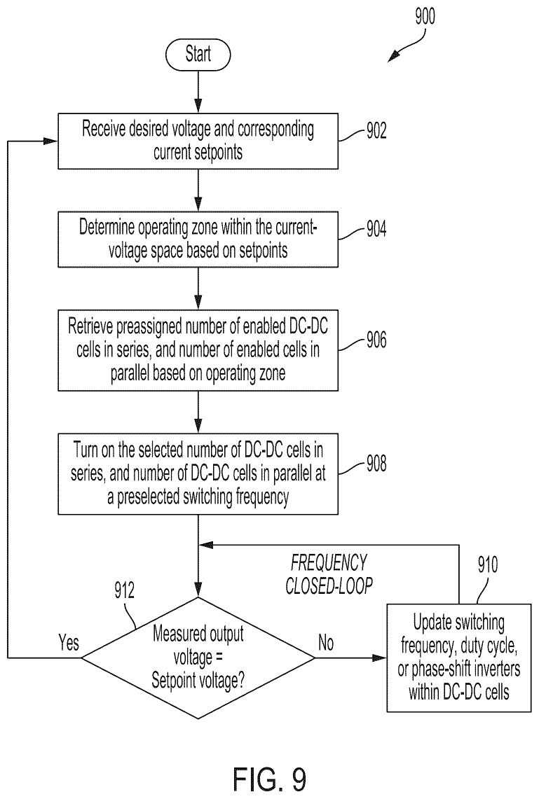

Various example methods for controlling the system 100 by utilizing the above-described regions are described herein. Additional reference is made to FIG. 9, which shows a flow diagram describing one such method 900. An operational block 902 involves the controller 106 receiving a desired output voltage set point and a desired output current set point, which may be derived, for example, from the desired output voltage and a load impedance value. Based on the desired set points from operational block 902, the system 100 (e.g., the controller 106) may determine the operating region, such as from Table 1 and FIGS. 7 and 8, for the system 100 as described in operational block 904. In operational block 906, the system 100 may

retrieve a preassigned number of series and parallel enabled DC-DC converter cells 110 (e.g., stored in system memory) in a feedforward mode. In operational block 908, the system 100 may enable the selected DC-DC converter cells 110 at an initial operating frequency that can be predefined distinctly for each region, or identically for all regions. The system 100 may then enter a closed-loop mode where one or more of the: cell switching frequency, duty cycle, or phase-shift, is dynamically adjusted such that the output voltage converges to the desired set point as illustrated in processing block 910 and decision block 912. For example, in some examples according to the present disclosure, the output voltage V_{SYS} can be caused to converge to the desired set point by entering the closed-loop mode in conjunction with dynamically adjusting the switching frequency of one or more of the DC-DC converter cells 110.

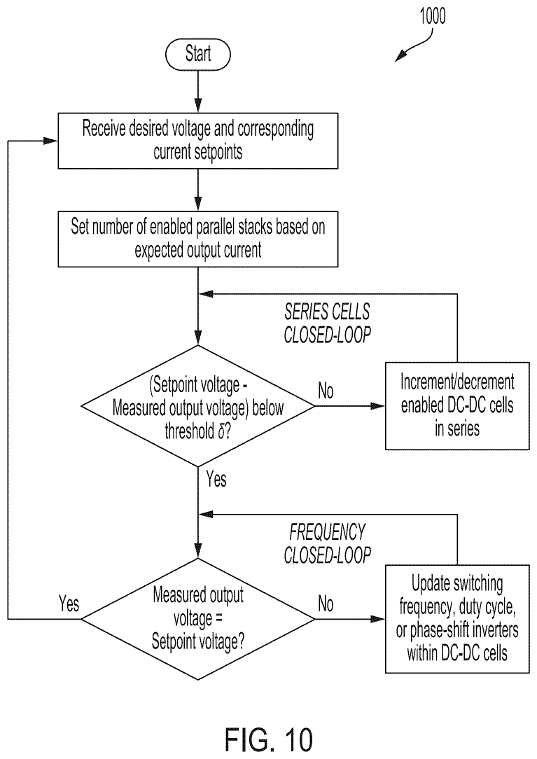

FIG. 10 shows another example method 1000 of operating the system 100 of FIG. 1, wherein a number of enabled parallel stacks 116 can be enabled or disabled based on corresponding output current set points. The method 1000 of FIG. 10 may use a coarse closed-loop voltage feedback to set the number of series enabled DC-DC converter cells 110, and another closed-loop feedback for fine control of particular output signal parameters. The coarse closed-loop voltage feedback may be run first, wherein the selective engagement of the DC-DC converter cells 110 may include discrete enabling and disabling of certain DC-DC converter cells to coarsely achieve an output voltage V_{SYS} that is within some predefined threshold δ from a given desired output voltage set point. Once the output voltage is achieved, the system 100 may enter a closed-loop mode with the system 100 (e.g., the controller 106) controlling (e.g., by adjustments and/or re-settings) of particular signal parameters such as frequency, duty cycle, and/or phase-shift, to achieve a relatively finer output voltage control V_{SYS} as compared to the threshold &.

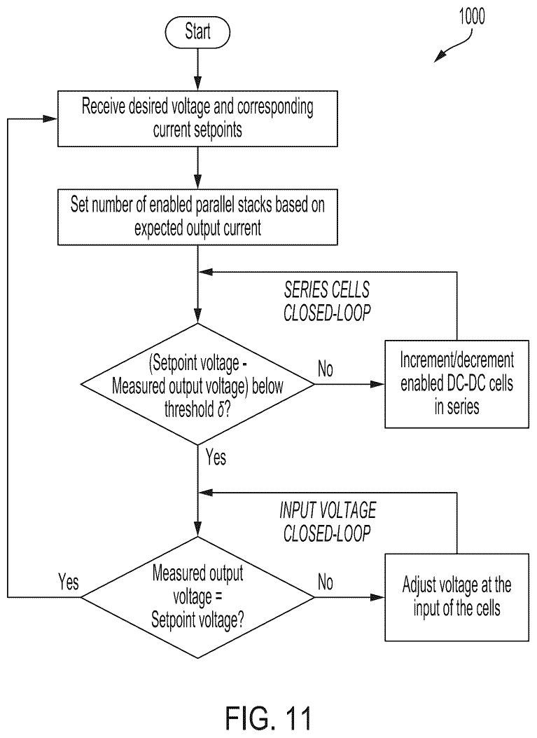

Another method 1100 of operating the system 100 of FIG. 1 is shown by the flow diagram of FIG. 11, and includes input voltage variation and feedback control. More specifically, FIG. 11 shows a block diagram illustrating a method 1100 of controlling such a system 100 by using coarse closed-loop voltage feedback for the selective engagement setting the number of series enabled DC-DC converter cells 110, and another closed-loop feedback for fine control by adjusting the DC voltage rail at the input of the DC-DC converter cells 110 from the source 112. In other words, in addition to a closed-loop mode for coarse control by enabling/disabling certain DC-DC converter cells 110, fine control adjustment may be achieved by adjusting the input DC voltage from the source 112 to the DC-DC converter cells 110. Depending on the speed with which input voltage can be varied, the approach of FIG. 11 may be beneficial when output voltage convergence to the desired set point is allowed to happen at a slower time scale than would be possible with a closed-loop based on cell switching frequency, such as within several pulse cycles.

In some embodiments, it may be required to generate a pulse voltage waveform that repeats in time at some repetition rate. Some applications may dictate narrow pulse widths (e.g., 1 s or 10 s of μs) that can make settling to the desired voltage set point difficult to achieve on the first pulse. Such cases may utilize control methods better suited for pulsed applications that allow the system 100 to learn from previous pulses, and can thus allow the system 100 to reuse the system configuration from previous pulses. The system 100 may then operate starting with those system parameters and then adjusting parameters of the DC-DC converter cells 110 such as cell switching frequency, duty cycle, phase shift, or combinations thereof, until the desired output voltage V_{SYS} is reached or parameters of the DC-DC converter cells 110 exceed predetermined bounds. In these examples, the system 100 may adjust the number of enabled DC-DC converter cells and repeat adjustment of cell parameters. This process may repeat until the desired output voltage V_{SYS} is achieved.

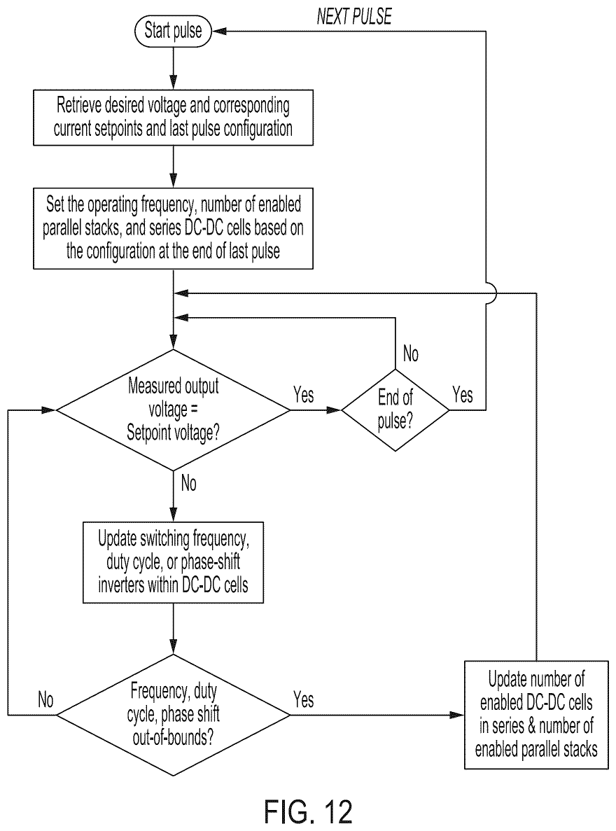

FIG. 12 shows an example of one such control method 1200, wherein at the start of a new pulse, the controller 106 retrieves from a memory database (e.g., in the controller 106: the desired output voltage(s) and corresponding current set points, and other system configuration parameters (i.e., for supplying power to the load 136), at the end of the last or previous pulse. This data retrieval, in various example embodiments, may include a specified ones (or a number of) of enabled series and parallel DC-DC converter cells 110, operating frequency, duty cycle, phase-shift, and/or other control parameter(s) as may be appropriate.

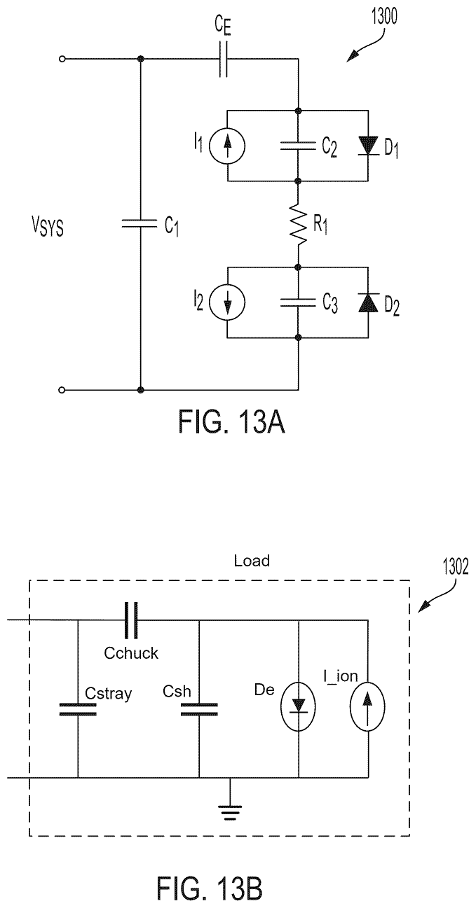

To demonstrate the utility of the system 100 shown in FIG. 1, an example system is designed and simulated for a typical semiconductor processing bias load model. FIG. 13A shows one such circuit model 1300 that may be used in semiconductor bias applications and FIG. 13B shows another circuit model 1302 that may be used in semiconductor fabrication applications. The components in circuit model 1300 can take on a wide range of values. Table 2 below shows example component values of the load circuit model 1300 in the simulations described hereafter. Experimental examples, according to the present disclosure, demonstrate how the system 100 can be used to synthesize the desired bias voltage waveforms (e.g., the waveform shown in FIG. 32A) with adjustable waveform parameters, including on-time, falling slope, and inflection point. Such examples also show how rise and fall times change as the total number of DC-DC converter cells 110 in the system 100 may be, scaled.

TABLE 2

| Component | Selected value in simulation |
|---|---|
| I₁ | (3/j) A |
| I₂ | (7/j) A |
| C₁ | (500 pF)/j |
| C₂ | (200 pF)/j |
| C₃ | (7 nF)/j |
| C_{E} | (8 nF)/j |
| R₁ | (7*j) Ω |
| D₁, D₂ | Ideal diodes |
| j | 8, 16, 24, 32, 64 |

With reference to Table 2, “j” refers to the number of stacks 116 of sixteen series coupled DC-DC converter cells 110 that are coupled in parallel. For example, to achieve a total of 128 cells in the system 100, eight of the 16-cell stacks would be coupled in parallel so j would be assigned the value of 8, and so on.

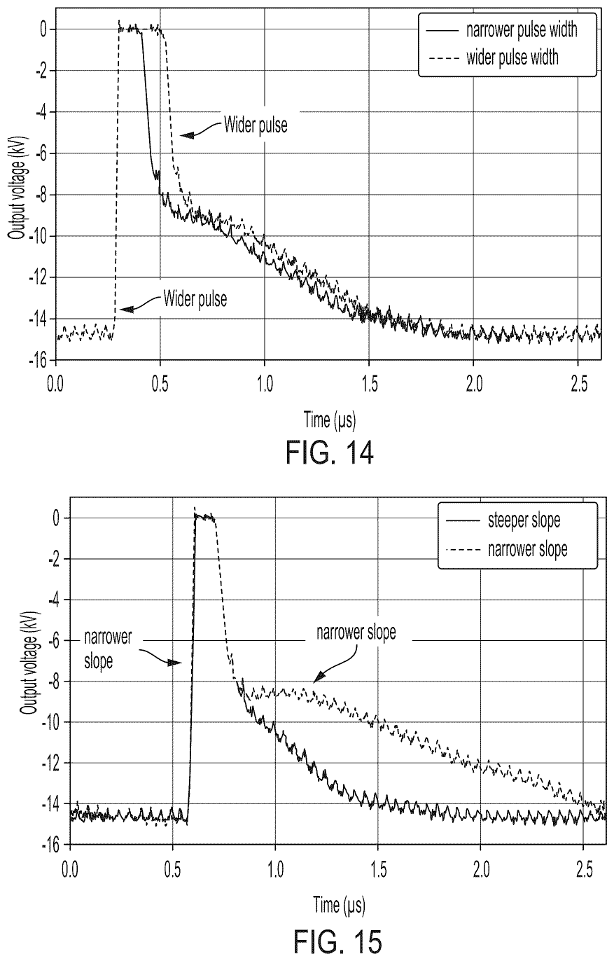

According to various examples of the present disclosure, output waveforms can be adjusted, for example, by way of the controller 106, which may include logic circuitry, as described herein. FIG. 14 shows an example of the output voltage waveforms V_{SYS} having different pulse widths (i.e., different on-times). The pulse on-times can be adjusted arbitrarily. In the example of FIG. 14, the pulse width may be adjusted by adjusting the timing and number of enabled DC-DC converter cells 110.

FIG. 15 shows an example of the output voltage waveforms V_{SYS} with different falling slopes during the portion of the waveform after completing the prescribed on-time(s). Controllability of the rising or falling slope of the voltage V_{SYS} during such portions of the waveform may be desirable in some applications, such as in some semiconductor manufacturing processes. In some embodiments of the system 100 disclosed herein, the slope can be adjusted in real time by controlling the output voltage V_{SYS} to track a sequence of control set points. Multiple control devices can be used to achieve the adjustments. For example, and as described herein, in this simulation example, the waveforms with the different slopes were generated by simulating the system 100 in an open-loop configuration and by controlling the number of enabled DC-DC converter cells 110 over time.

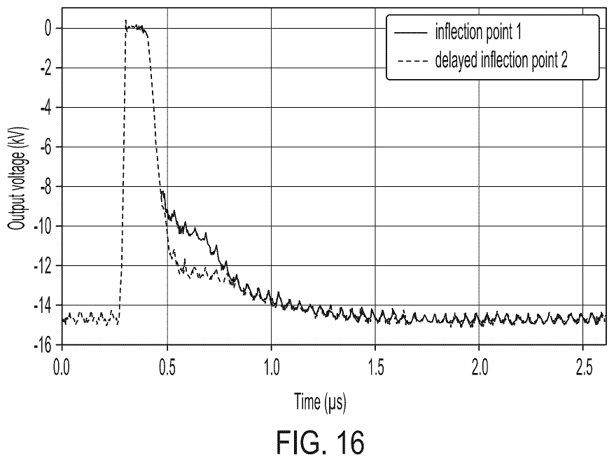

FIG. 16 shows an example of another simulated demonstration wherein the output voltage waveforms of the voltage V_{SYS} show different inflection points, which are the instants marking the start of the controlled-slope portion of the waveform described herein. The inflection point may be adjusted by controlling output voltage during the fall time. In this example, inflection point 1 begins just before 0.5 μs (microseconds) (at around −9 kV) while inflection point 2 begins just after 0.5 μs (at around −12 kV).

As shown from the plots described herein, the system 100 may be capable of adjusting specific aspects of the waveform shape. In some embodiments, such as in the aforementioned examples described wherein the timing and/or number of enabled DC-DC converter cells 110 are dynamically adjusted, the system 100 may switch the output voltage V_{SYS} at tens of nanoseconds.

Another aspect of the present disclosure is the scalability to higher or different numbers of stacked DC-DC converter cells 110. As disclosed herein, the examples of arrangement of stacked DC-DC converter cells 110 may be widely varied by the scalability of the system 100. In experimental efforts leading to the present disclosure, modifications of simulation examples demonstrate tradeoffs in scaling to a higher total number of converters while using the same design of the DC-DC converter cells 110. The system 100 described herein may include a relatively large range for total number of DC-DC converter cells 110 (e.g., 360 total DC-DC converter cells 110, in some specific instances with on the order of a hundred or hundreds of DC-DC converter cells 110 such as between 128 and 1024 total DC-DC converter cells 110), and the pulse rise time may be measured (going from 5% to 95% and 10% to 90%) and the fall time (ranging from 5% to 95%).

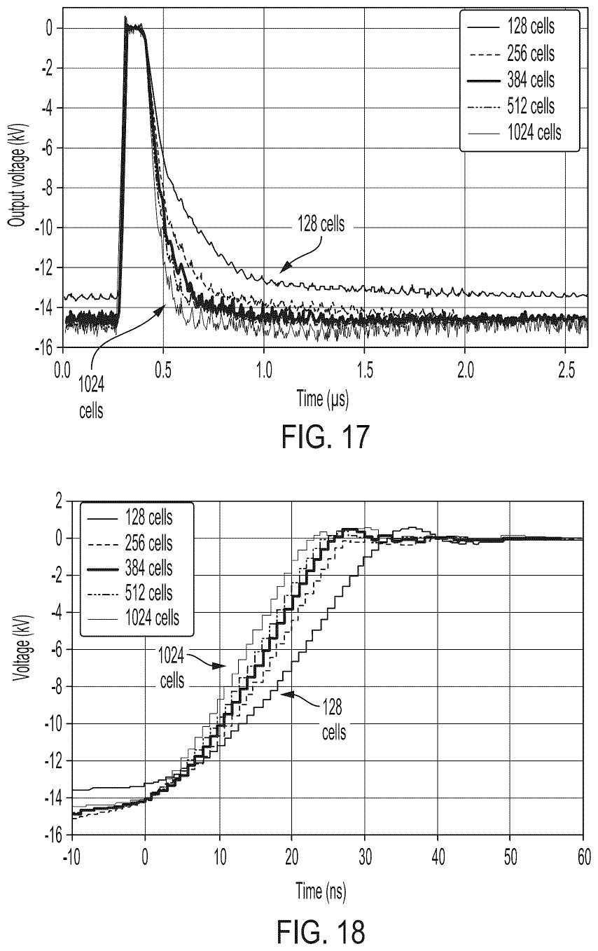

FIG. 17 shows examples of the overall shapes of the voltage waveforms V_{SYS} for different numbers of selected DC-DC converter cells 110. It is noted that the plot lines on the right of FIG. 16 are depicted in the same order as in the legend, from top to bottom. As shown in FIG. 17, using a higher number of DC-DC converter cells 110 in the system 100 can generally result in faster rise and fall times of the output voltage V_{SYS}.

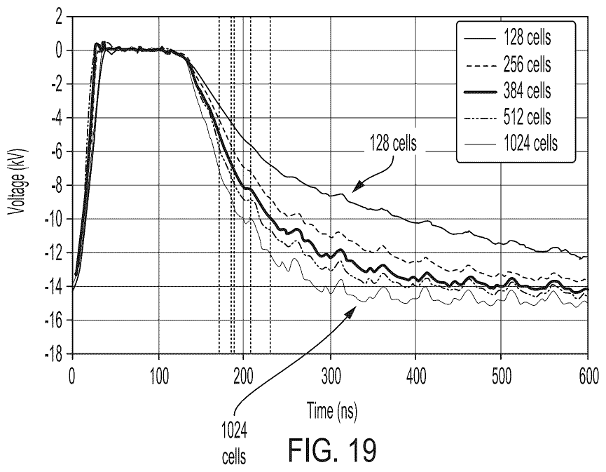

Reference is made to FIG. 18, which shows a zoomed-in view in the vicinity of rising edges of the output voltage V_{SYS}. The vertical plot lines of FIG. 18 are depicted in the same order as in the legend, if viewing the plot lines from right to left. FIG. 19 shows a zoomed-in view in the vicinity of pulse falling edges of the output voltage V_{SYS}. It is noted that the plot lines on the right of FIG. 19 are depicted in the same order as in the legend, from top to bottom. In all the aforementioned examples, sixteen DC-DC converter cells 110 may be stacked in series, and several of these stacks may be coupled in parallel to achieve the indicated total number of DC-DC converter cells 110. The extent to which more DC-DC converter cells 110 in the system 100 affect the rise and fall times of a given output voltage pulse V_{SYS} may depend upon the exact implementation of the system 100, including the switching stage(s) shown in FIG. 1.

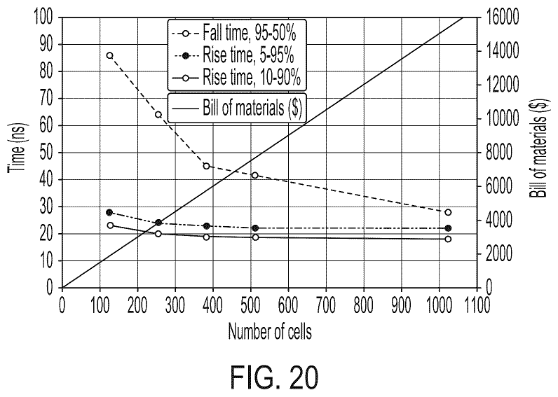

Reference is made to FIG. 20, which is plots showing estimates of the cost of the bill of materials (BOM) for systems using different of numbers of DC-DC converter cells 110. In one such example estimate, the results shown in FIG. 20 indicate that increasing the total number of DC-DC converter cells 110 in the system 100 results in a linear increase in the cost of the BOM. The results also show an appreciable reduction in rise and fall times of the output voltage pulse V_{SYS} as the number of DC-DC converter cells 110 is increased to about 384. Beyond that number, however, increasing the number of DC-DC converter cells 110 in this example provides diminishing returns due to rapidly increasing BOM cost and no significant reduction in rise or fall times. However, in some embodiments, increasing the number of DC-DC converter cells 110 may result in a reduction in discrete step size in output voltage V_{SYS} (e.g., as a percentage of total output voltage) as a result of enabling or disabling individual ones of the DC-DC converter cells 110. Accordingly, and based at least in part from the example simulated demonstrations, there may be an optimal total number of DC-DC converter cells 110 to be used in the system 100 for a given design of the DC-DC converter cells 110 and a given output waveform requirement.

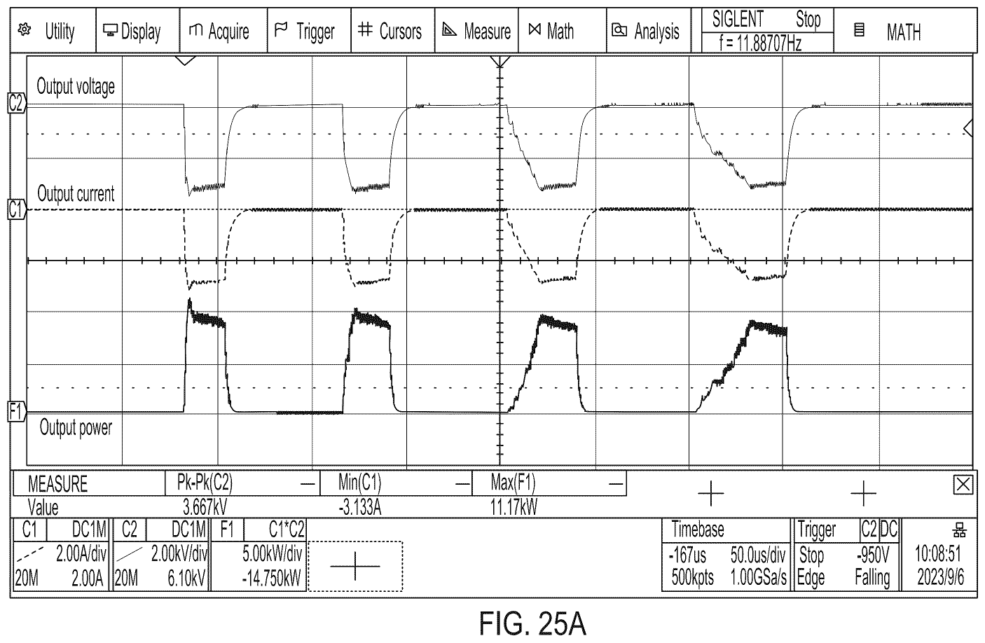

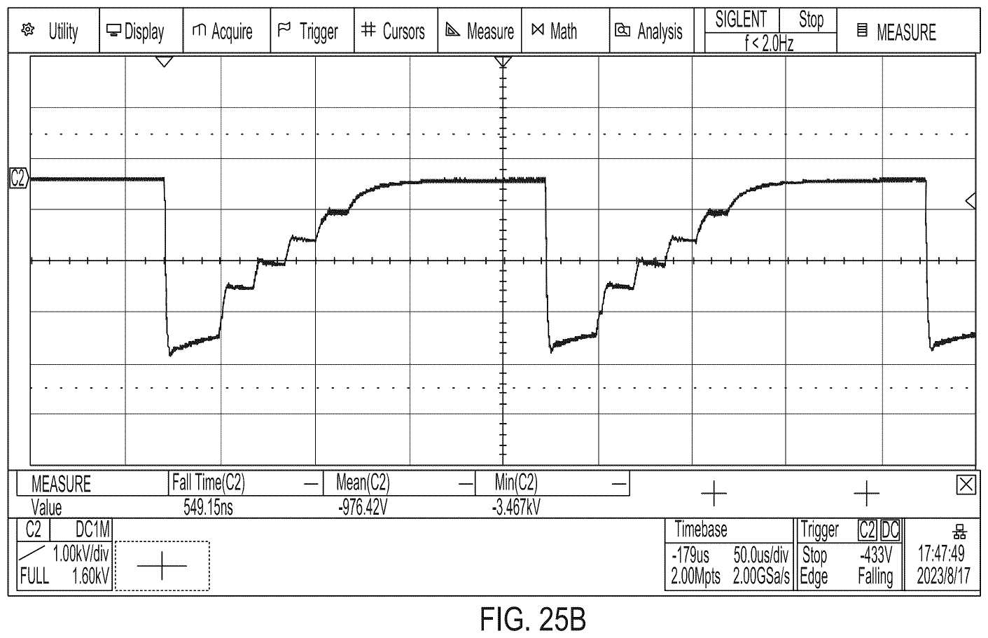

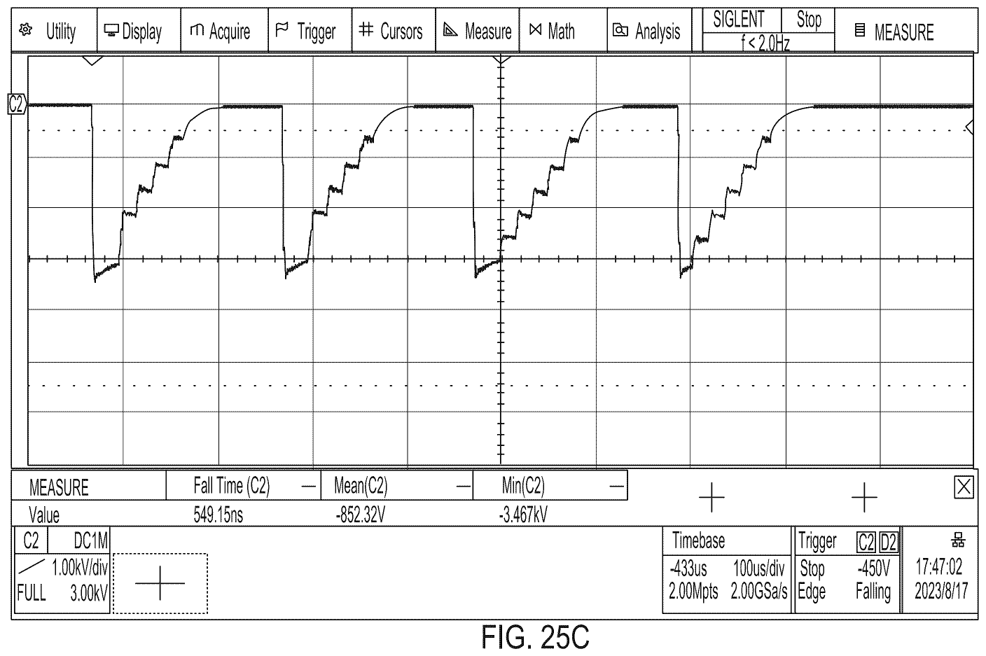

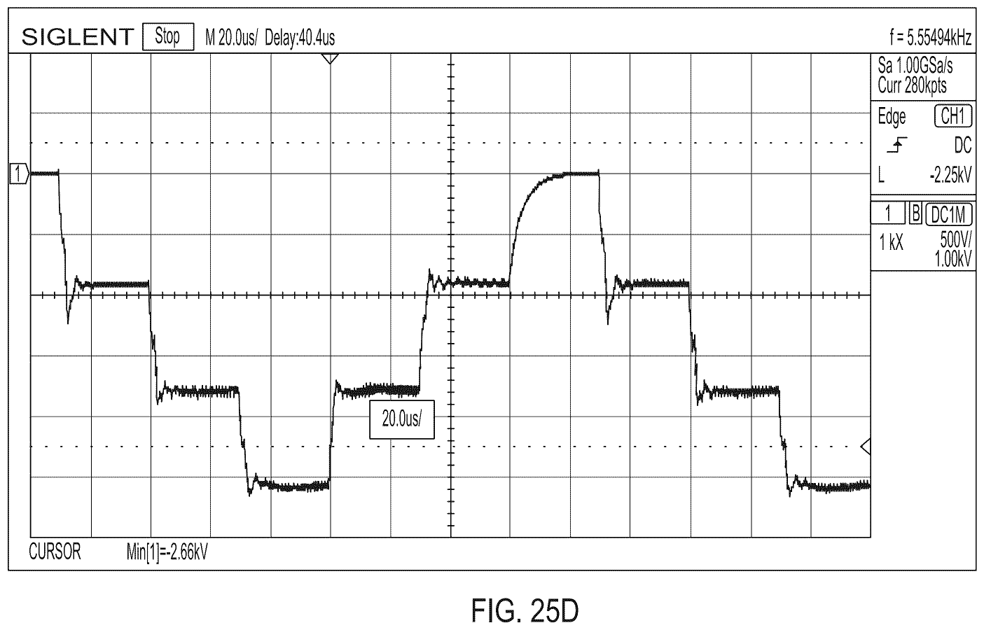

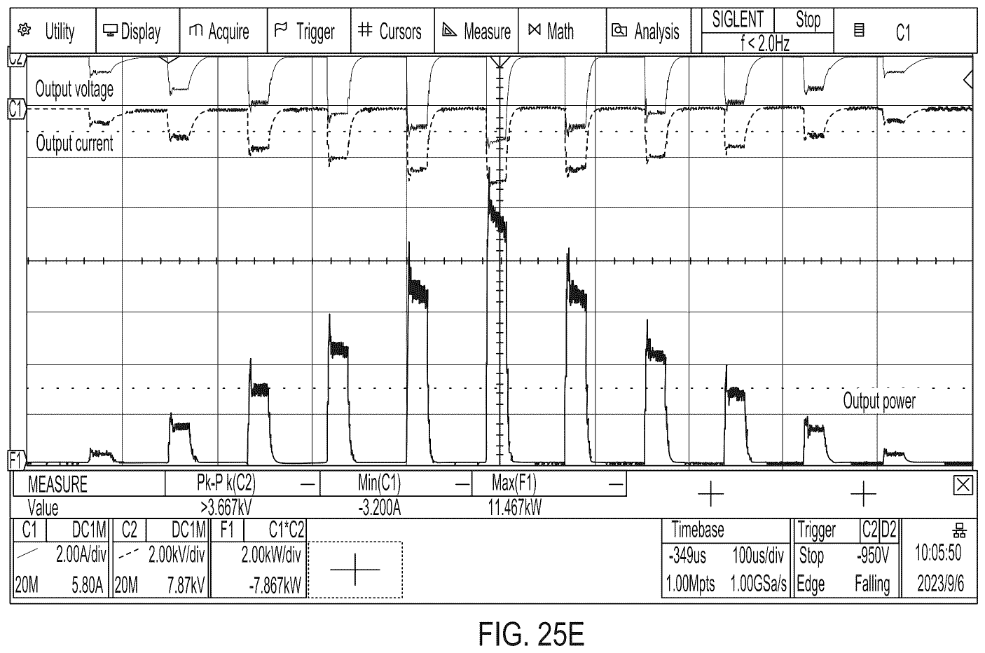

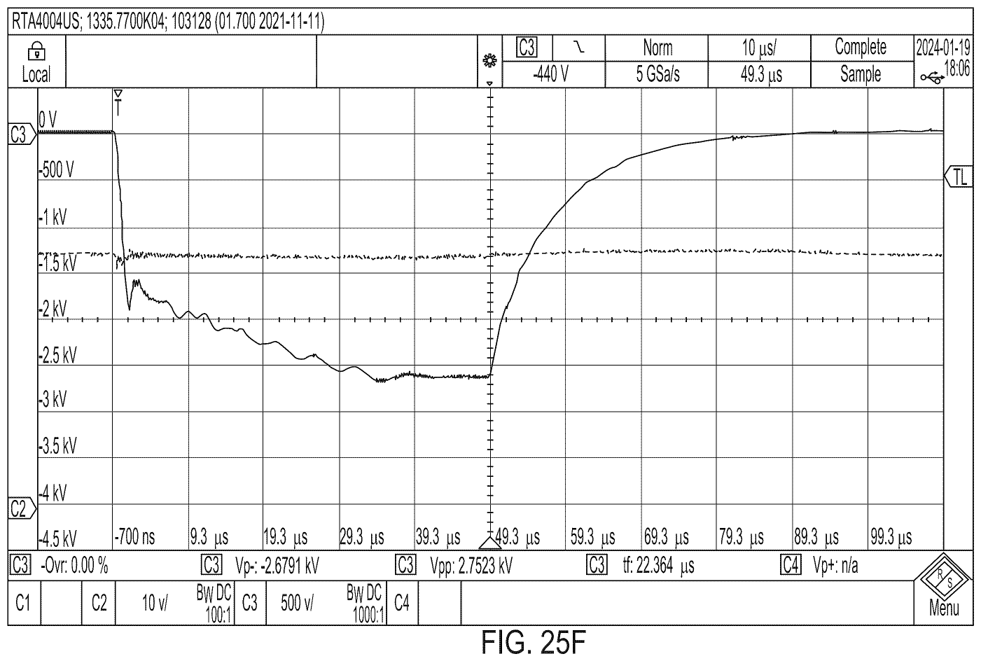

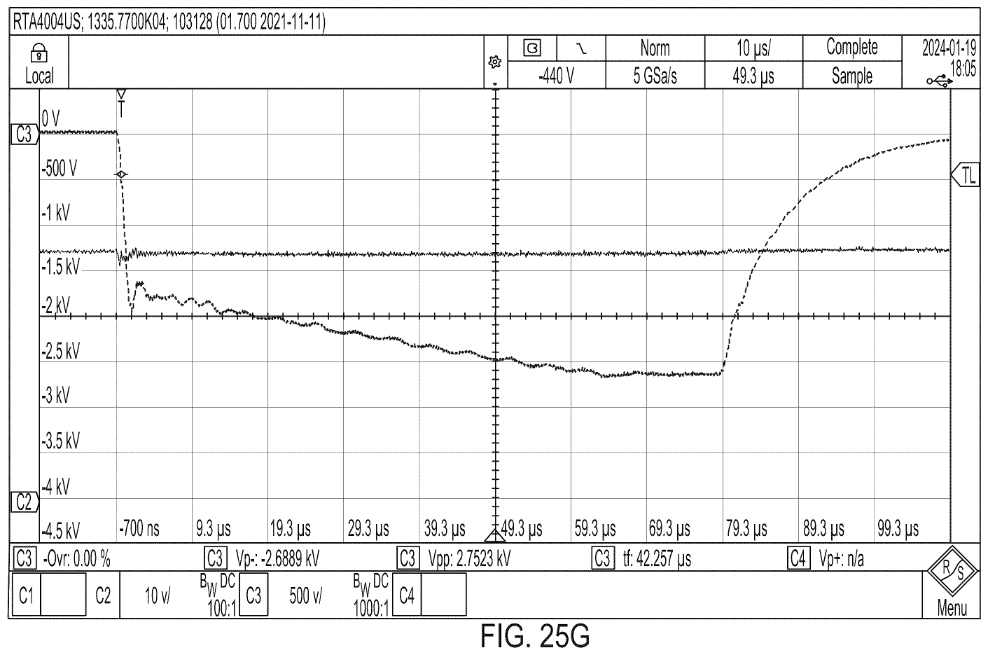

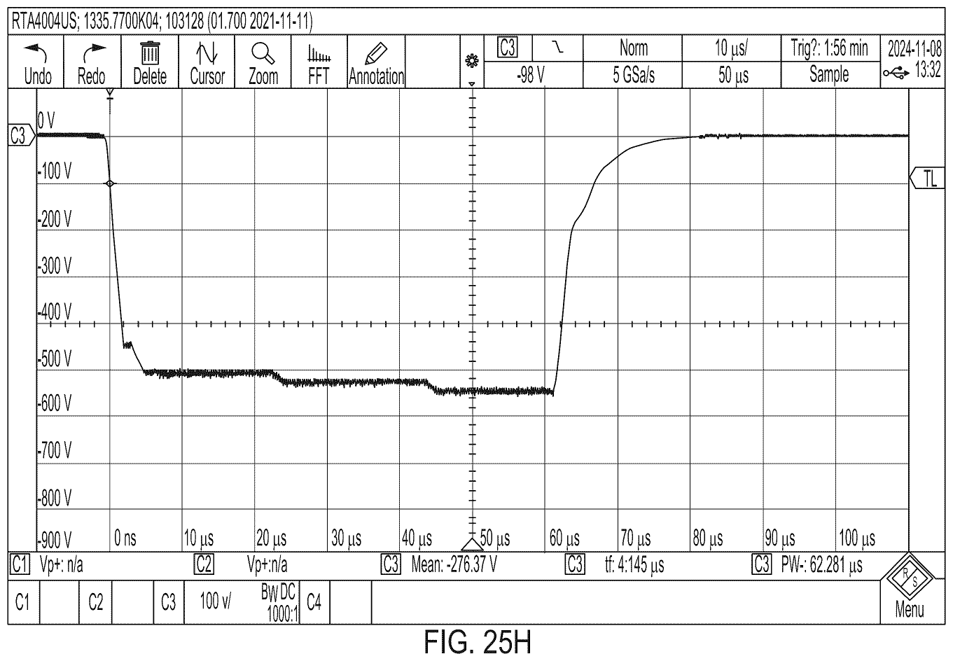

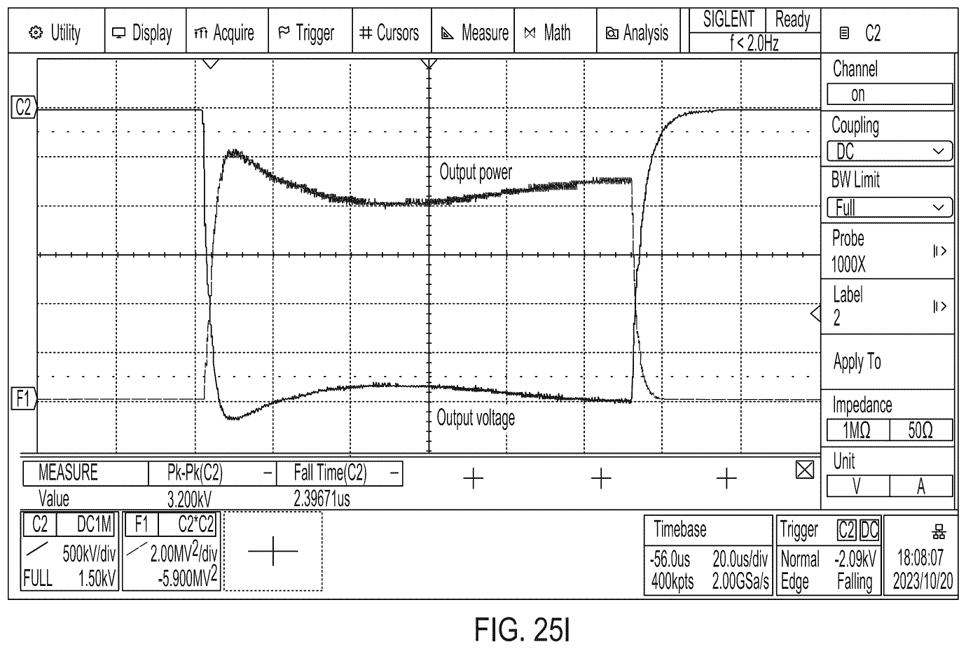

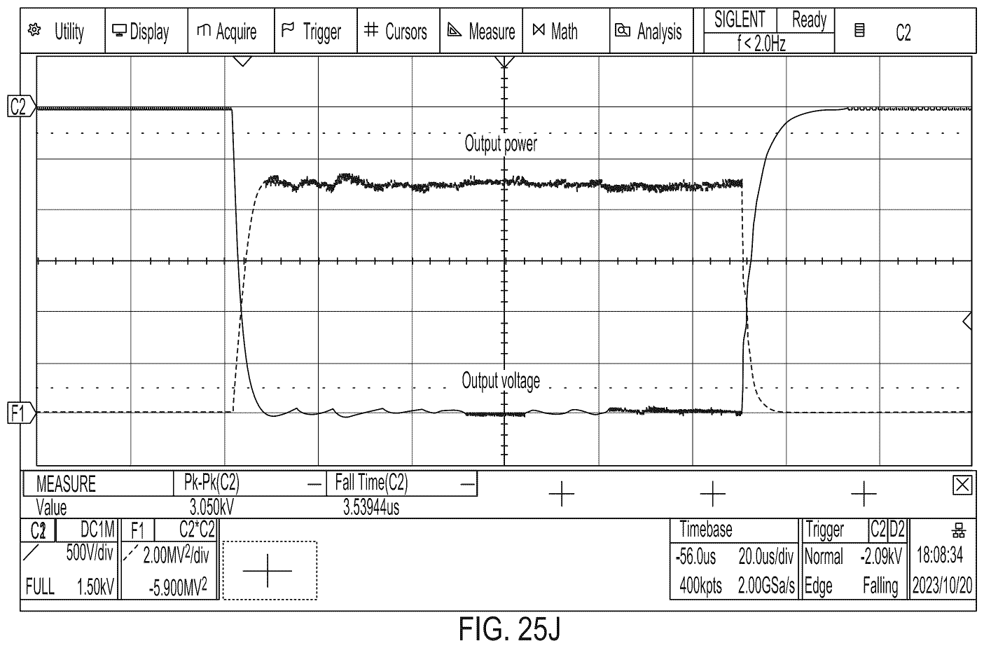

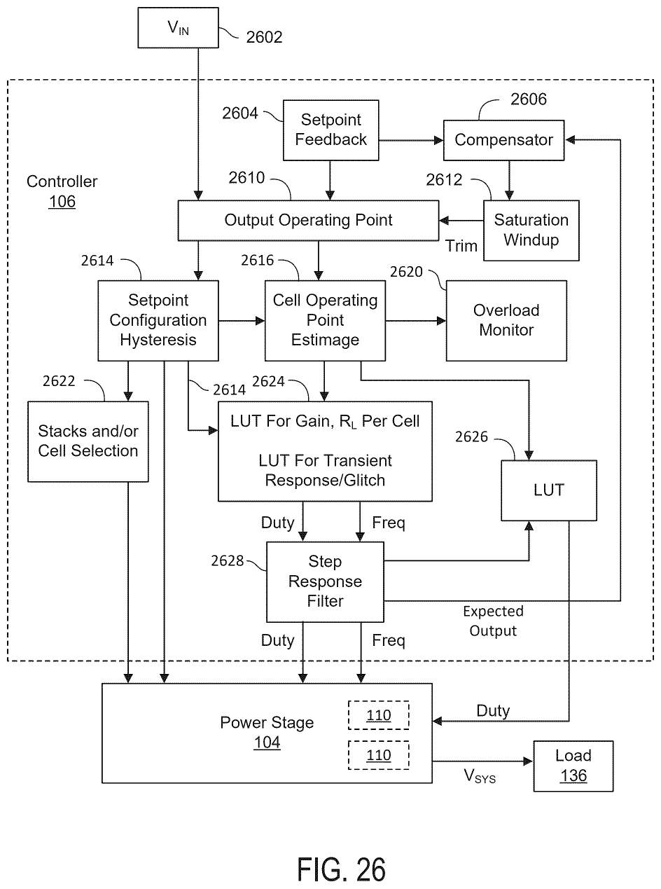

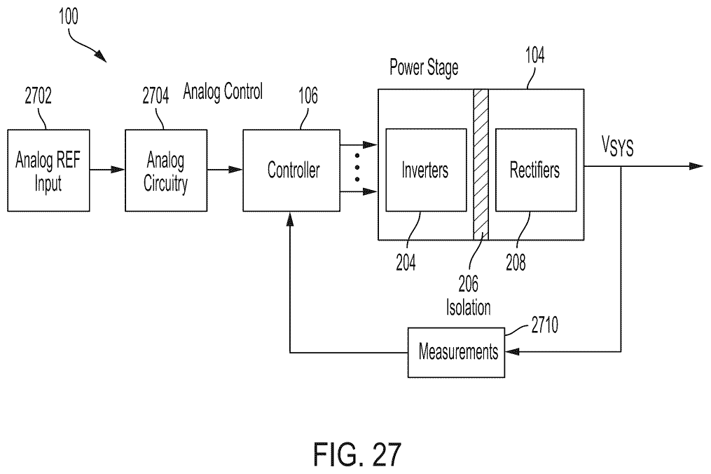

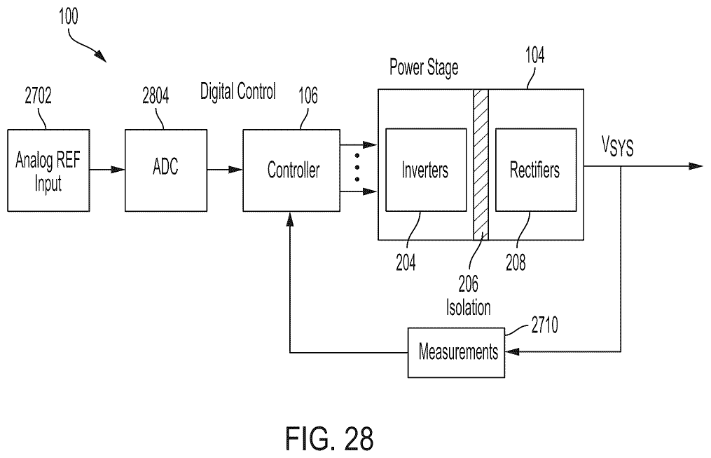

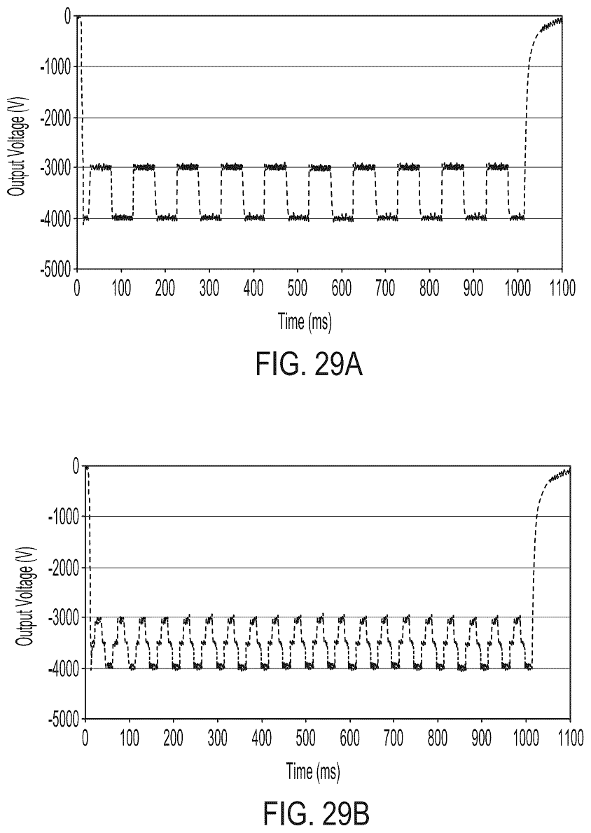

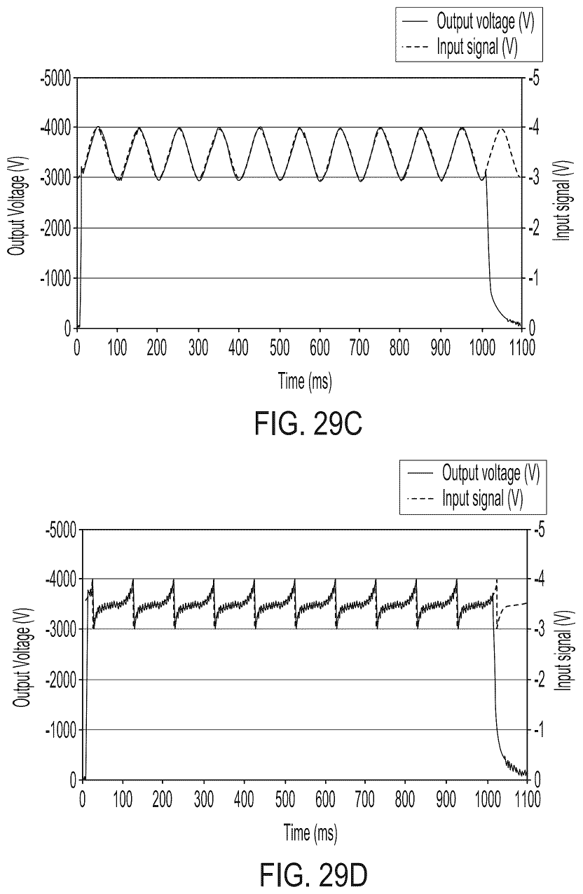

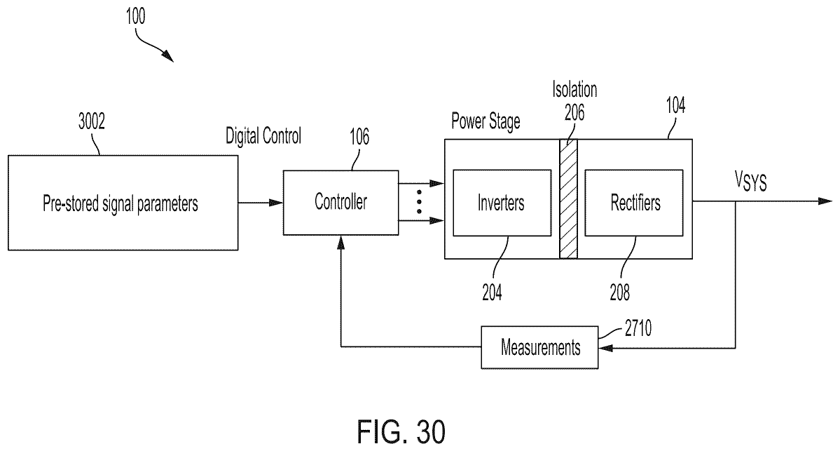

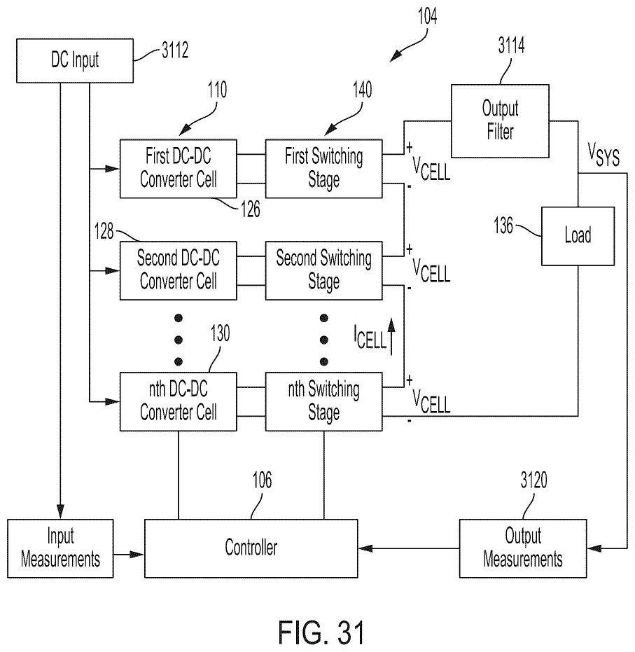

Other aspects of the present disclosure relate to the controller 106 used to control signal overshoot in the output signal V_{SYS} provided by a stacked configuration of DC-DC converter cells 110. In addition to controlling signal overshoot of the output voltage V_{SYS}, the selective engagement may be used to control rise time, shaping, and efficiency (as disclosed here, for example, in connection with discussion of FIGS. 25A-25E).

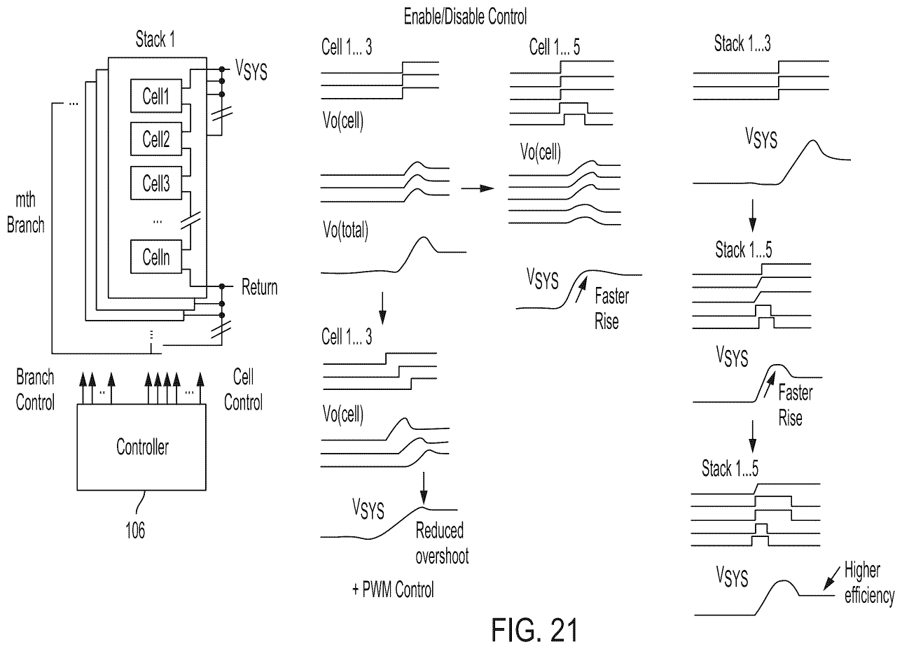

Additional reference is made to FIG. 21, which is a control block (e.g., logic circuitry) of an embodiment of the controller 106 sending control signals to selectively engage certain DC-DC converter cells 110 in and among a stacked arrangement of DC-DC converter cells 110. The example of the DC-DC converter cells 110 of FIG. 21 may control output overshoot in the output signal V_{SYS} at the output terminal of the DC-DC converter cells 110. FIG. 21 describes a specific example of the system 100 and the controller 106, in which the DC-DC converter cells 110 are configured and selectively engaged while coupled in series as stacked cells and/or coupled in parallel branches. The system 100 of FIG. 21 may configure the DC-DC converter cells 110 to operate within the load range available through frequency control. However, the DC-DC converter cells 110 can also be used to control shaping of the transient response (outside of frequency controls) and optimize efficiency of the system 100. This may be realized, for example, by staggering the turn on of different DC-DC converter cells 110 coupled in series which can reduce the overshoot to that of a single series DC-DC converter cell; however, this may increase the rise time of the output voltage V_{SYS}. Turning on additional ones of the DC-DC converter cells 110 or stacks 116 during the rise can provide additional current into the output capacitance and/or resistance of the load 136 (also FIGS. 13A and 13B) and reduce the rise time. The number of DC-DC converter cells 110 that are activated can also be adjusted to have limited effect on overshoot of the output voltage V_{SYS}. Turning off one or more of the plurality of stacks 116 after the initial transient can shift the operating point of the DC-DC converter cells 110 to a more efficient operating point and reduce losses either for the system 100 or even individual ones of the DC-DC converter cells 110.

With additional reference to FIG. 2, depending on the configuration of the DC-DC converter cells 110, enable lines may asynchronously modulate the gate drive signals G1 and G2 to the inversion stage 204 or be processed to internally control the turn-on transient. This may be performed by having a pre-programmed response or processing method stored in the controller 106 that generates pulse width modulated (PWM) signals. In embodiments of the system 100 that utilize field-programable gate array (FPGA) systems and other systems, the system 100 may adapt the widths of the first pulses, delay turn on to a certain phase relative to the switching, phase shift the two sides of the push pull in the circuit 200, or generate an arbitrary PWM waveform triggered by an enable signal with or without modification based on the switching frequency of a clock input.

The gate drives to Q1 and Q2 can also be modulated to mix with a common operating frequency with the enable frequency, or at a much lower frequency to effect PWM control. In some example implementations this approach generally may not optimize an efficient control input but advantageously it may provide some intermediate levels without involving phase shift. In embodiments wherein the open loop response of the DC-DC converter cells 110 depends on operating frequency (such as in resonant conversion topologies), enable control via the gate drive signals G1 and G2 can be more effective when combined with suitable frequency selection. Additionally, the controller 106 can use the frequency or open loop response information to adjust the enable sequence and timing. The system 100 may use DC-DC converters 110, wherein filter impedances, delays, etc. depend on the frequency. Because an RF modulated signal may be passed instead of an LF component (e.g. for a buck-type system), the operating frequency may be generally expected to affect both the static output characteristic (IV curve) and dynamic output characteristics (e.g. represented by modulation bandwidth and step response).

According to further examples of the present disclosure, control of signal overshoot may be realized by using the controller 106 to generate enable and/or disable signals for a circuit including one or more of the plurality of stacks 116 of DC-DC converter cells 110 having respective outputs connected in series to provide an aggregated output voltage V_{SYS} based on the respective outputs. The controller 106 may include logic circuitry and may be configured to mitigate or eliminate output overshoot in the aggregated output voltage V_{SYS} by selectively activating certain DC-DC converter cells 110 in the plurality of stacks 116. In other embodiments, the controller 106 may sequentially control the DC-DC converter cells 110 by at least one of selective enablement and disablement; selectively controlling activation of the DC-DC converter cells 110 to effect respective delays in contributions by the activated DC-DC converter cells 110 to the aggregated output voltage V_{SYS}; or selectively controlling at least one of activation and deactivation of the DC-DC converter cells 110 by adjusting or modulating one or more frequencies of certain of the activated DC-DC converter cells 110.

In other examples and as described herein, the mitigation or elimination of output overshoot in the aggregated output voltage V_{SYS}: may be realized starting certain sets of the gate drive signals G1 and G2 with one or more higher initial switching frequencies and thereafter reducing the frequencies (optionally, without thereafter adjusting one or more frequencies); and/or may be realized by selectively adjusting one or more voltage set points characterizing a subset of the DC-DC converter cells 110 or by selectively adjusting one or more output voltages generated by a subset of the DC-DC converter cells 110.

Further aspects of the present disclosure may include use of different power rails to reduce isolation barrier requirements on high-speed DC-DC converter cells 110 by reducing voltage stresses. FIGS. 22A-22C show alternative block diagrams for respective approaches to provide power to a stacked arrangement of the DC-DC converter cells 110, with each of the individual DC-DC converter cells 110 including an isolation stage (See FIG. 2) as depicted within each of the individual DC-DC converter cells 110. FIG. 22A shows one approach having input signals to the DC-DC converter cells 110 referenced commonly to a single pair of power rails, which may not necessarily enable such reduction of the isolation barrier requirement. FIG. 22B, however, illustrates an alternative configuration in which input signals to certain of the DC-DC converter cells 110 are referenced to different sets of power rails. In certain regards, FIG. 22B illustrates multi-stepping the levels provided by the power rails to which the respective DC-DC converter cells 110 may be referenced.

In some examples, the power-rail configuration of FIG. 22A may be considered more of a default serial connection of DC-DC converter cells 110 for higher output voltages, wherein the inputs remain in parallel while the outputs are coupled in series. This approach has limited scaling for higher output voltages as the isolation barrier needs to be reliable up to the full peak level of the pulsed output voltage. To satisfy the isolation barrier needs, the thickness of one or more materials realizing such barrier may be increased, thereby reducing the magnetizing inductance of the transformer T1 (FIG. 2) and increasing the leakage inductance (doubly reducing the coupling coefficient). The thickness may refer to the thickness of an isolation barrier in the transformer T1, which is the separation between the primary and the secondary sides of the transformer T1. In some embodiments, the thickness may refer to the separation between separate ferrite core pieces used to guide flux around the primary and secondary sides of the transformer T1, which may form a magnetic gap. Compared to the configuration of FIG. 22B, this configuration may reduce the efficiency, power density, and response speed of the circuit 200, because the circuit 200 may need to be designed around excessive parasitic elements.

The configuration of FIG. 22B, as an alternative design, may overcome the above-described issues by including multiple high-voltage isolated DC rails to power inputs to the DC-DC converter cells 110. Therefore, while the outputs of the DC-DC converter cells 110 of FIG. 22B are still connected in series, the inputs can be referenced to intermediate voltages within the stack, and the isolation barrier stress may be limited to a fraction of the total output voltage V_{SYS}. In the example illustrated in FIG. 22B, by having four isolated input rails, the isolation barrier requirement may be reduced by roughly a factor of eight. As the dielectric thickness of the transformer T1 may not always scale linearly with voltage, the required barrier thickness can be reduced by more than the voltage stress. This allows the use of more efficient, compact, and cost effective DC-DC converter cells 110 for the generation of the required output voltage V_{SYS}. While a downside of this approach in certain implementations is that an additional isolated conversion step (and related conversion circuitry or one or more intermediate power supplies to provide the operating power at the different voltage levels as indicated in FIG. 22B) may be used for one or more inputs to the DC-DC converter cells 110, this type of DC-DC converter cell may have different requirements from the DC-DC converter cell that can make it easier and/or more advantageous. For example, while in operation and powering a DC rail, control bandwidth may be much less important, and energy storage can be connected to its output to provide the peak input power required by the load 136. Thus, in some embodiments, the DC-DC converter cells 110 may only need to deliver the average power requirement. In addition to a smaller transformer T1 to support average rather than peak power requirements, the isolation barrier capacitance can be further reduced without directly trading off the speed of the DC-DC converter cell (as may be the case with the single step configuration of FIG. 22A). This reduces the effective output load on the system 100, thereby reducing the rise time and stored energy.

The respective stacks of DC-DC converter cells 110 in the example of FIG. 22A may be compared to those in FIG. 22B by way of the following more-specific example embodiments. With reference to the stack of DC-DC converter cells 110 in FIG. 22A and viewing from a bottom DC-DC converter cell 2206 to a top DC-DC converter cell 2208, the isolation voltages for the DC-DC converter cells 110 in this example may be as follows: (1/8)V_{SYS}; (2/8)V_{SYS} [=(1/4)V_{SYS}]; (3/8) V_{SYS}; (4/8)V_{SYS} [=(1/2)V_{SYS}]; (5/8)V_{SYS}; (6/8)V_{SYS} [=(3/4)V_{SYS}]; (7/8)V_{SYS}; and (8/8)V_{SYS} [=V_{SYS}], respectively.

With reference to the stack of cells in FIG. 25B for this more-specific example, for the rightmost group of eight DC-DC converter cells 110, each of the DC-DC converter cells 110 may have an isolation voltage of (1/8)V_{SYS}. Each of the four intermediate DC-DC converter cells 2220 on the left of FIG. 25B may have an isolation voltage as follows: starting from a bottom cell 2224 to a top cell 2222 as follows: (1/8)V_{SYS}; (3/8)V_{SYS}; (5/8)V_{SYS}; and (7/8)V_{SYS}, respectively. In particular examples relating to the general configuration of FIG. 22B, if the output voltage V_{SYS} is a pulsed DC voltage, the four intermediate DC-DC converter cells 2220 may need to withstand only purely DC voltage, while the group of eight cells (in both FIG. 22A and FIG. 22B) need to withstand the pulsed DC voltage.

In view of the above, some aspects of the present disclosure are directed to various examples to reduce isolation barrier requirements on the DC-DC converter cells 110, which may be high speed converters. In some examples, a power converter (the system 100) may include: a stack 116 of DC-DC converter cells 110 (“converter cells”) having respective outputs V_{CELL} connected in series to provide an aggregated output voltage V_{SYS} based on the respective outputs V_{CELL}, and multiple DC rails, isolated from one another by one or more voltage-isolation barriers (e.g., isolation stage 206 FIG. 2), to provide operating power at different voltage levels to respective ones of the DC-DC converter cells 110. With access to respective ones of the multiple DC rails, the DC-DC converter cells 110 have respective input ports referenced to the different voltage levels.

FIG. 22C shows a block diagram of another example of the system 100 having a multi-step configuration to the configuration shown in FIG. 22B. The configuration of FIG. 22C shows DC-pulsed DC isolation stress reduced to % V_{SYS} with a separate DC-DC stage isolating up to V_{SYS}.

In some examples, the multiple DC rails may provide the operating power at high voltages (e.g., for about a 10 kV output volage V_{SYS}, the range may be about 1 kV to about 9 kV), respectively corresponding to the different voltage levels. In such examples, each of the one or more voltage-isolation barriers (e.g., 206—FIG. 2) may be capable of isolating voltages associated with immediately adjacent ones of the multiple DC rails at least in part as functions of material thickness and of a voltage differential, between the immediately adjacent ones of the multiple DC rails. The one or more voltage-isolation barriers may limit stress to a fraction of the aggregated output voltage V_{SYS}, on the one or more voltage-isolation barriers of immediately adjacent ones of the multiple DC rails. In some of these examples, each of the DC-DC converter cells 110 may include a transformer-based isolation stage as shown in FIG. 2, with a large difference of voltages on respective primary and secondary sides of the voltage-isolation barrier(s).

Accordingly, the foregoing discloses examples of different types of processes and apparatuses (e.g., system 100, devices, etc.) using a stacked arrangement of DC-DC converter cells 110 to produce a custom waveform shape at an output signal corresponding to an aggregation of individual output signals (V_{CELL}) from the respective DC-DC converter cells 110. Via selective engagement of respective ones of the DC-DC converter cells 110, output signals V_{CELL} from the DC-DC converter cells 110 are combined to generate an aggregate (e.g., high-voltage) output signal V_{SYS} having a waveform shape that is customized based on the selective engagement. Other examples leverage inherent fast response times of the DC-DC converter cells 110 by using nanosecond level pulsing for precise control over the DC-DC converter cells 110 in order to tailor high-voltage waveshaping of the aggregate output signal V_{SYS} as derived from the DC-DC converter cells 110.

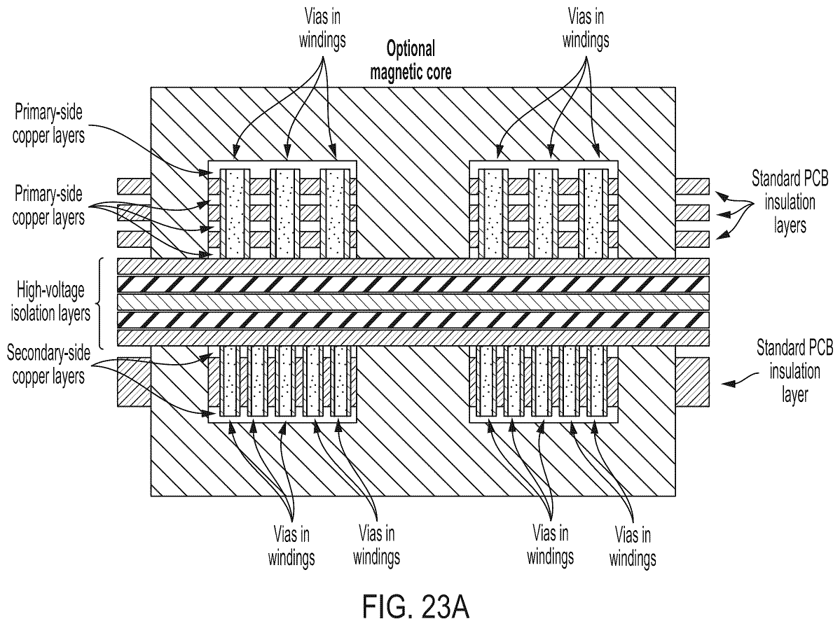

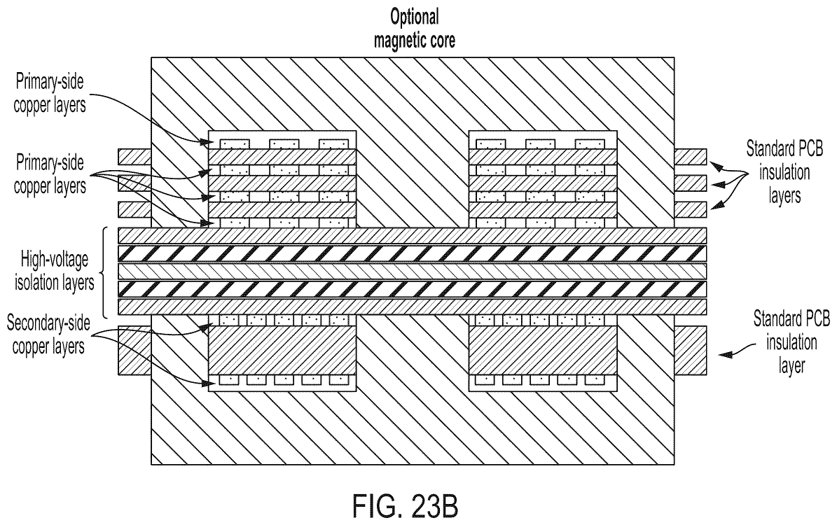

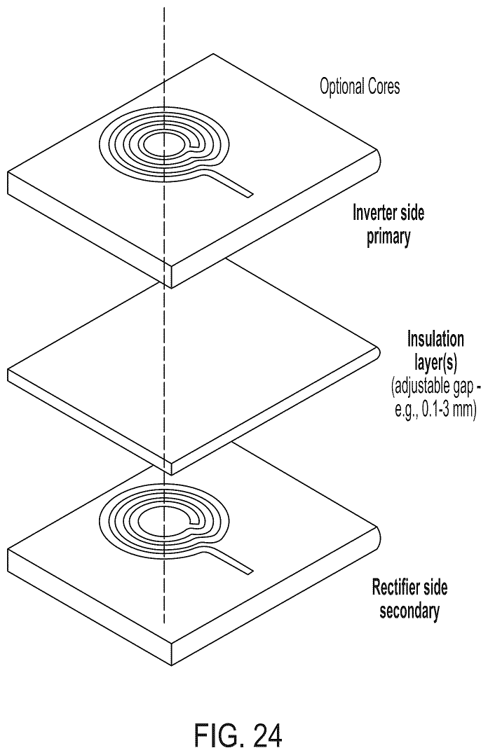

Further aspects of the present disclosure are directed to example configurations for primary and secondary windings of a planar-type transformer-based isolation stage (e.g., isolation stage 206—FIG. 2) as part of a PCB (printed circuit board). The examples of FIGS. 23A and 23B may be used in the circuit 200 (FIG. 2) of the inversion stage 204 and isolation stage 206 of one or more of the DC-DC converter cells 110. As example embodiments of such a planar-type transformer-based isolation stage, FIG. 23A and FIG. 23B are diagrams showing respective cross-sectional views for corresponding planar transformers, either of which is applicable to a transformer-based implementation of one or more of the DC-DC converter cells 110 shown in FIG. 1, with FIG. 23A indicating there are vias dispersed throughout the planar windings (e.g., improving thermal issues) on different layers, and FIG. 23B showing normal planar windings. FIG. 24 is an exploded view of a PCB planar transformer which may be used with one or more of the DC-DC converter cells 110 depicted for the system 100 of FIG. 1 (e.g., showing a PCB planar transformer having an architecture common to all such DC-DC converter cells 110).

In the example configurations of FIGS. 23A, 23B and 24, a transformer may be implemented with primary and secondary windings implemented using planar traces in PCB layers. These example configurations are not limited to being used with one or more of the circuits depicted for the system 100 of FIG. 1, but they have been found to be beneficial in terms of small form factor (e.g., minimal PCB real estate), voltage isolation, and other parameters improving operation of the system 100 of FIG. 1.

In connection with each of the example configurations of FIGS. 23A and 23B, the transformer may have a primary winding and one or more secondary windings (e.g., both spiral windings), integrated with a multilayer PCB, with the windings shaped to minimize eddy current losses. The PCB may have the layers implemented for securing traces for the primary windings and for the secondary windings, and may include vias through certain of the traces to minimize winding losses and to facilitate thermal conductivity. Further, the PCB, the primary winding, and the secondary winding may be cooperatively stacked vertically to facilitate magnetic coupling between the primary winding and the secondary winding.

In more specific examples that build on the above examples, such configurations may be implemented for realizing advantages that depend on the specific design, PCB space constraints, and power and thermal requirements and/or constraints. In certain of these examples, a number (X) of layers secure traces for the primary winding, and another number (Y) of layers may secure traces for the secondary winding, wherein X and Y are integers. In each of the examples of FIG. 23A and FIG. 23B, X may be four and Y may be two. The number and placement of the vias, being different in FIG. 23A and FIG. 23B, may be defined in part by the traces for the primary winding and by the traces for the secondary winding for the purposes of minimizing winding losses and to facilitate thermal conductivity.

The primary and secondary windings may have corresponding portions therein with different widths at sections nearest one another to minimize eddy current losses, or may have corresponding portions at sections nearest one another, with gradually decreasing trace width towards a center of the windings, to minimize eddy current. Also, at least one of the primary and secondary windings may have a section with a trace having a narrower width nearer the center of the winding and nearer an outer edge of the winding, and wider traces nearer the middle of the winding. The primary and secondary windings may also be cooperatively arranged with minimal overlap to minimize parasitic capacitance between the primary and secondary windings. In different examples, the primary and secondary windings may be spiral windings or other forms and shapes of windings (e.g., square, rectangular windings and/or a combination of shapes such as spiral, square and/or rectangular).

In yet further examples in this context, the PCB may include at least one insulating material between each set of traces that are cooperatively arranged to provide magnetic coupling, or multiple insulating material types to provide, respectively, at least two levels of isolation protection including a high-voltage isolation protection nearest the transformer and another isolation protection. The high-voltage isolation protection may be nearest the transformer than other ones of the insulating material types and may provide an increased degree of voltage isolation protection than isolation protection provided by the other ones of the insulating material types.

Having described embodiments of the system 100, scope shots of voltages generated by the system will now be described. FIGS. 25A-C show scope shots illustrating adjustability of rise or fall time slopes between consecutive pulses by timing the turn-on and turn-off of the DC-DC converter cells 110 of FIG. 1 in a prescribed sequence.

FIGS. 25D-E show scope shots illustrating adjustability of pulse peak voltage levels by timing the turn-on and turn-off of the DC-DC converter cells 110 of FIG. 1 in a prescribed sequence to obtain customized voltage waveforms.

FIGS. 25F-G show scope shots depicting example pulse fall time adjustment of the output voltage V_{SYS} of the system of FIG. 1 by ramping the operating frequency of the DC-DC converter cells 110.

FIG. 25H shows a scope shot illustrating the use of frequency stepping on the DC-DC converter cells 110 of FIG. 1 to generate a smooth voltage level adjustments within a pulse of the output voltage V_{SYS}.

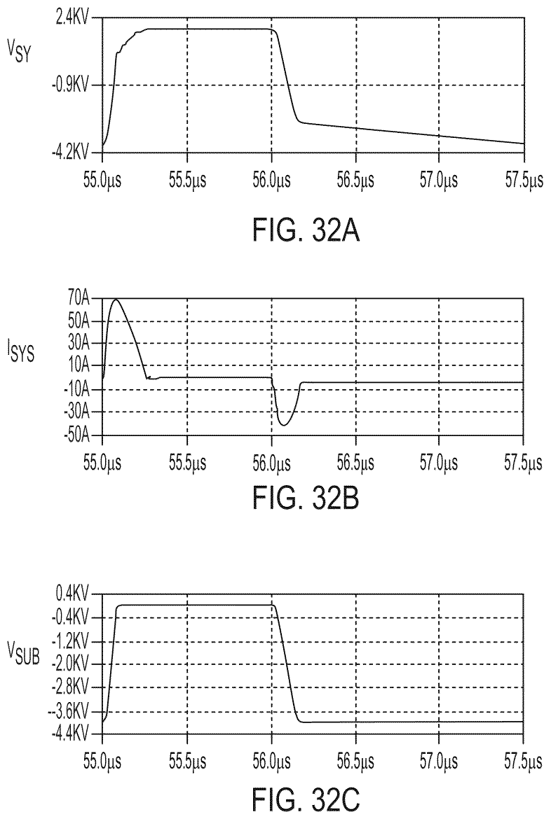

FIGS. 251-J show scope shots illustrating the use of frequency adjustment within a pulse of the output voltage V_{SYS} of the system 100 of FIG. 1 to correct for input voltage rail variation effects using a feedforward configuration.

Having described various embodiments of the system 100 various embodiments of the power stage 104 and the controller 106 will now be described.

The controller 106 may generate control signals (e.g., G1 and G2—FIG. 2) to generate waveforms, such as pulsed high voltage waveforms as the output voltage V_{SYS}. The controller 106 may generate signals to cause the power stage 104 to generate the waveforms by amplifying an input waveform form the source 112 or by using one or many feedback and/or feedforward algorithms. The waveform of the output V_{SYS} may be tuned by changing parameters including rise time, fall time, pulse width, and peak voltage. However, the controller 106 may cause the power stage 104 to generate unique or customized waveforms with settable slopes, multipeak waveforms, bipolar waveforms, and other parameters. One or more of these parameters may be used to control ions or materials affected by the output voltage V_{SYS}, such as when the system 100 is used for semiconductor fabrication. In some embodiments, the control of the output voltage V_{SYS} may enable the system 100 to function as a constant current source at high-bandwidths.

In these and other contexts according to the present disclosure, more specific examples are apparent with reference to FIG. 1. In some of these examples, maintenance of the load 136 being driven by the power stage 104 source over periods of time may be realized by monitoring the outputs of the DC-DC converter cells 110 and/or the aggregated signal V_{SYS} at the output terminal where the respective outputs of the DC-DC converter cells 110 are combined, and providing feedback to the controller 106. The controller 106 may then adjust the voltages output by the DC-DC converter cells 110 based on the measured output voltage V_{SYS}.

In some embodiments, the controller 106 may correlate the voltage adjustments on signs of degradation of components of the load 136 and/or other components in the system 100. Such correlation may be realized by retrieving historically collected data from previous operations of similar loads (e.g., similar in terms of types of uses, components used, initial high voltages used with certain components susceptible to stress, etc.). By using a look-up table (LUT) that may include collected data associated with stored configurations of the DC-DC converter cells 110 settings for such conditions (e.g., specific to the load 136 and/or component(s) used in the load 136), the configuration settings may be retrieved and used by the controller 106 to drive the gate signals G1 and G2 (FIG. 2) of the DC-DC converter cells 110 that are to be activated to generate the output signal or voltage V_{SYS}.

In one or more of the examples provided herein, artificial intelligence (AI) and/or machine learning (AI/ML) may be used to effect configurations for the tuning of the DC-DC converter cells 110 in the system 100. For example, as described herein, feedforward and/or feedback modes of operation of the system 100 may be used in various ways to ensure proper signal generation. In some examples, the system 100 may utilize threshold-level comparators as part of the measurement circuitry to monitor the output voltage V_{SYS} and make adjustments to the DC-DC converter cells 110. In other examples, the system 100 may use power-related parameter (e.g., voltage and/or current) measurement circuits to monitor the outputs of the DC-DC converter cells 110 and/or the output V_{SYS} to adjust the DC-DC converter cells 110.

The controller 106 may use these measurements in combination with data pre-stored in one or more look-up tables or by algorithm-executing data-processing computing circuitry to assess current and/or past measurements when adjusting the DC-DC converter cells 110. In some embodiments, the controller 106 may learn and/or predict which parameters to set for the DC-DC converter cells 110 and which or how many the DC-DC converter cells 110s to engage for ensuing signal generation in an initial course mode and/or for subsequent fine tuning.

The embodiments described herein can also be applied using a service provider that collects, maintains and provides correlated configuration information on the basis of the several factors including, but not limited to, the type of load 136 being used, how long the load 136 has been in use, and various stress factors such as types and ratings of circuitry being driven by the system 100. The service provider may provide load-specific data correlated to the controller 106, such as via a computer (e.g., server) node connectable to a network connection. The network connection may connect the controller 106 to one or more of a plurality of client entities that may operate disparately (e.g., in competition with one another, parallel to one another, or vertically oriented with respect to one another; e.g., as a supplier or receiver of industry goods such as akin to the system 100 and/or the load 136. In this context the controller 106 may be configured to receive configuration data from one or more disparate entities and/or a database from which load-specific correlated configuration information may be stored. The data received by the controller 106 may be evolved by ML from one or more of the disparate client entities for predicting (using AI) the optimal way to configure one or more of the loads (e.g., load 136) which is driven by the system 100 and may be operated by the different client entities.

Methods for controlling the power stage 104 may include adjusting the input voltage to the inversion stages 204 (FIG. 2), the switching frequency of the constituent power devices, phase shift between different ones of the inversion stages 204, duty cycles of the gate signals G1 and G2, and/or selective engagement and/or disengagement of different inverter-rectifier stages within the overall power stage 104, such as in the individual one of the DC-DC converter cells 110.

Reference is made to FIG. 26, which illustrates a block diagram of an embodiment of the controller 106 and operation of the controller 106. The controller 106 may control the DC-DC converter cells 110 in the power stage 104 by enabling certain ones of the DC-DC converter cells 110 and/or controlling frequency and/or duty cycle of the selected DC-DC converter cells 110 as described herein. Such control of the DC-DC converter cells 110 enables the controller 106 to cause the power stage 104 to output a predetermined or customized output waveform, which may be V_{SYS}. In some embodiments, the controller 106 may control the DC-DC converter cells 110 based on a plurality of factors described herein.

The controller 106 of FIG. 26 may be configured to be coupled to an input voltage sense 2602 that may be configured to identify operating points for the DC-DC converter cells 110 and provide feedforward input for transient management. The input voltage sense 2602 is shown external to the controller 106; however in some embodiments, the input voltage sense 2602 may be within the controller 106. Setpoint-feedback 2604 may provide input for the input setpoints and output (e.g., voltage, current, and/or other parameters such as temperature or load parameters) feedback. In some embodiments, the input voltage sense 2602 may be an input voltage, wherein the system 100 may be a proportional converter, which may provide higher efficiency by limiting operation to specific operating points around a specified gain. The input voltage sense 2602 may also be an arbitrary voltage setpoint depending on the configuration of the system 100.

The compensator 2606 (also referred to as a proportional-integral-derivative (PID) servo or PID loop) may be a slow loop that corrects for steady state errors from the feedforward controller. In some embodiments, the compensator 2606 may use a different controller method and may provide a linearized plant which may be controlled with a linear controller such as a PID. The output operating point 2610 may monitor the output operating point, which may be instantaneous voltage and current and may also include future operating point estimations by sensing a voltage step in the setpoint and anticipating an output current transient accordingly.

A saturation windup 2612 may be referred to as a saturation anti-windup and may monitor an output of a DC correctness loop to detect operating anomalies, limit corrective effects, and flag the system if anomalies are detected. A setpoint configuration 2614 may have hysteresis and, based on the output operating point 2610, may configure the number of parallel stacks 116 (sometimes referred to as “bricks”) and series DC-DC converter cells 110 to activate for the specific output operating point 2610. Hysteresis may prevent unnecessary switching of the configurations of DC-DC converter cells 110 and plurality of stacks 116. Some embodiments of the setpoint configuration 2614 may not include hysteresis. The cell operating point estimate 2616 may, based on the configuration of the DC-DC converter cells 110 and the plurality of stacks 116, and the output operating point 2610, estimate a per-cell operating point for the DC-DC converter cells 110. In some examples, the estimating is not absolute because voltage and current sharing may not be guaranteed, and there may be variables contributing to the estimation, such as variable amount of diode drop voltages, that may be accounted for to make accurate estimations.

An overload monitor 2620 may monitor the cell operating point estimate 2616 and may determine loss and SOA compliance of the DC-DC converter cells 110 and may flag or shut down the system 100 if conditions are unexpected or exceed predetermined thresholds. The stacks and/or cell selection 2622 may set a configuration of the DC-DC converter cells 110 and/or the plurality of stacks 116. The stacks and/or cell selection 2622 may be programmed to the power stage 104 semi-arbitrarily and may distribute loss, for example, between the DC-DC converter cells 110 and the plurality of stacks 116. The stacks and/or cell selection 2622 may enable cycling through different ones of the DC-DC converter cells 110 and/or the plurality of stacks 116.

The gain LUT 2624 may be a primary lookup table (LUT) and may store characterizations of the responses of the DC-DC converter cells 110, which may be used for open loop feedforward operation of the system 100.

The LUT 2626 may store various duty cycle settings for the DC-DC converter cells 110 for desired outputs. In some embodiments, the operation of the DC-DC converter cells 110 may be primarily influenced by the frequency of signals enabling the DC-DC converter cells 110 and only slightly affected by the duty cycle. The operation may be different is the duty cycle is extremely different than an optimal value. The duty cycle (alternatively, on time or off time) may be used primarily to optimize the efficiency of the DC-DC converter cells 110, and can be determined at a slower speed than an operating point of the DC-DC converter cells 110. Therefore, a more resource efficient configuration of the controller 106 may have the duty control implemented in the LUT 2626, which may be a separate module rather than increasing the dimensions of the gain LUT 2624.

A step response filter 2628 may control the step response and modify the gate signals G1 and G2 (FIG. 2) in the time domain. The step response filter 2628 may be used instead of relying on the gain LUT 2624 or making the gain LUT 2624 more expansive to cover both fast transient conditions and the operating point (e.g., DC operating point) of the DC-DC converter cells 110.

The controller 106 may use a load estimation and an embedded power stage model to work around a nonlinear power stage frequency response. For example, the gain LUT 2624 may be able to approximate a nonlinear power stage 104 by allowing encoding of arbitrary results for each input rather than being constrained to representing the power stage 104 with a specific (typically linear) function as a standard compensator (e.g. PID controller) would. However, populating the gain LUT 2624 may require intensive characterization or modelling of the DC-DC converter cells 110.

The load estimation may determine an output operating point of voltage and current based on an estimation of characteristics of the load 136. An example of a load characteristics is load impedance, an example of which is provided in FIGS. 13A-13B. Over time, components constituting the load 136 may change, which may change the impedance of the load 136. The controller 106 may compensate for the changes in impedances and other characteristics as described herein.

The compensator 2606 may function in parallel with the above-described components and may monitor the error between a set point of the output voltage V_{SYS} (e.g., waveform) and an expected output voltage or waveform. The parallel functioning may refer to the manner in with the low frequency compensator 2606 and feedforward operate simultaneously on the same feedback and setpoint signals. However, the eventual power stage operating point may be the combination of the outputs.

In some embodiments, the compensator 2606 may servo the controller 106 in an open loop configuration over a smaller range of the saturation windup 2612, which may limit the output of the compensator 2606 to within a predetermined compensation range. The limited range may be useful because if significant adjustment is required, the adjustment may indicate that the model of the power stage 104 used by the controller 106 may not be accurate.

The output of the controller 106 may be configured to cause the power stage 104 to function as a linearized “ideal” power stage, which can also have relaxed control bandwidth requirements as the total controller bandwidth may be extended by an open loop feedforward block extending from the setpoint-feedback 2604 to the inversion stage 204 (FIG. 2). Additionally, the power stage model can provide a signal of the expected output voltage and current for each of the DC-DC converter cells 110 to the overload monitor 2620 and the entire system 100 for control and monitoring the DC-DC converter cells 110. This allows integration with additional control modules for estimation of power loss and other stress factors. These additional control modules may not track the setpoint input, but, as an example, they may perform SOA monitoring and output power foldback based on the losses of the DC-DC converter cells 110 and/or ambient temperatures for example.

Because the power stage 104 may require a specific number DC-DC converter cells 110 coupled in series to provide predetermined operating points, the controller 106 may be used to identify and output the series configuration of coupled DC-DC converter cells 110 based on the set output. In some examples, the number of DC-DC converter cells 110 can be determined based on only the set output voltage and may not change during operation of the system 100, or may only change in response to a change in the output voltage set point. In other examples, the power stage adjustment range may depend heavily on output current, or voltage may not be the regulated parameter. In the former example, a condition for each operating range may be all that is required. The operating range may refer to voltage operating range. For example, if each of the DC-DC converter cells 110 can be controlled between 50-100 V in a normal control mode, the DC-DC converter cells 110 may have 0-50 V in a low voltage control mode, 50-100 V with one of the DC-DC converter cells 110, 100-150 or 200 V with two of the DC-DC converter cells 110, etc.

In the latter example, the series configuration of the DC-DC converter cells 110 may be dynamically updated based on the input or output conditions, or drift of the power stage 104, which may require setpoint configuration hysteresis 2614 to be implemented. Implementing the setpoint configuration hysteresis 2614 may depend on the controller 106 and power stage 104 requirements. Other methods to limit range switching and reduce glitch energy in applications which can reduce or eliminate the need for hysteresis in the range selection may be used. The implementation may include having different thresholds for each transition direction, for example, 1→2 cells may occur at 105 v while the 2→1 cell transition may occur at 95 v.

Dynamic switching of the DC-DC converter cells 110 may change the operating conditions of one or more of the DC-DC converter cells 110, which may result in some output transients at the output V_{SYS}. The output transients can be reduced by feedforward of the switching event on the DC-DC converter cells to frequency controls to provide a compensating response. For example, when the number of DC-DC converter cells 110 changes, there can be a brief moment where either extra ones of the DC-DC converter cells 110 are active (e.g., enabled) or there may be turn on/frequency change overshoot that may produce a positive (magnitude) glitch. In other examples, there may be insufficient power delivery, which may be a negative glitch. These issues can be largely mitigated by sequencing the operating frequency around a cell configuration transition. For example, for transitioning from one cell at 3 MHz to two cells at 5 MHz, the sequence might be to first run the one cell at 4 MHz, turn on the additional cell, and then transition to 5 MHz, avoiding a substantial overshoot from running two cells at 3 MHz or undershoot from running one cell at 5 MHz.

The change in configuration of the DC-DC converter cells 110 can also be delayed to reduce glitch energy (V*s) of the output V_{SYS}. To further shape the transient behavior for output waveform adjustment and converter operating stress reduction, the step response filter 2628 can be applied to the frequency output of the power stage model. The step response filter 2628 may apply to both step responses of the entire system 100 or step responses of individual ones of the DC-DC converter cells 110 during configuration switching as described herein. In the latter case, even if the output voltage does not change significantly, an individual one of the DC-DC converter cells 110 can rapidly change its voltage, which may be controlled by the step response filter step response filter 2628.

The same aspects of hysteresis and compensating feedforward may apply to the parallel configuration, which can require dynamic reconfiguration to limit loss per DC-DC converter cells 110, optimize efficiency, or achieve a certain control response from the frequency modulation. The parallel configuration may apply to pluralities of stacks 116 coupled in parallel and may be done with the same general methods described herein. In some examples, it may be advantageous to change the number of active plurality of stacks 116 depending on the output voltage and current (and operating point of the DC-DC converter cells 110) for the reasons described herein.

Other embodiments of the present disclosure are directed to using fast feedback control for arbitrary pulse shaping, and such use may be implemented for example, in an arrangement of DC-DC converter cells 110 as depicted in FIGS. 1 and 22A-22C. In some embodiments, the system 100 may generate voltage and/or current waveforms that have arbitrary shapes, including a superposition of a constant direct-current (DC) value and an alternating-current (AC) component which may or may not be purely sinusoidal. If the bandwidth of the AC component is lower than that of the feedback control loop for the power stage 104, one or more DC-DC converter cells 110 that can switch at the frequency of the AC component may produce the AC component. In such embodiments, the controller 106 may track a desired reference signal at the input voltage sense 2602 or the source 112 (FIG. 1). The reference signal can be provided externally in analog or digital form, stored in internal memory, or provided through other means to the controller 106 as described in greater detail herein.

Examples of the controller 106 processing data to cause the power stage 104 to generate specific waveforms will now be described. Reference is made to FIG. 27, which illustrates an example of the system 100 configured to receive a reference signal that is an analog signal. The system 100 of FIG. 27 may receive an analog reference signal 2702 by way of analog circuitry 2704 which may step down, amplify, filter, and/or condition the signal such that it is suitable for processing by the controller 106. In the embodiment of FIG. 27, the controller 106 may receive measurements 2710 from the output V_{SYS}. The controller 106 may compare the measurements 2710 from the output V_{SYS} with the analog reference signal 2702 and may generate appropriate signals (e.g., G1 and G2—FIG. 2) to operate the power stage 104. For example, the signals generated by the controller 106 may enable and disable specific ones of the DC-DC converter cells 110 in the power stage 104 as described herein. Thus, the signals generated by the controller 106 may operate inversion stages 204 (FIG. 2) and/or isolation stages 206 within the DC-DC converter cells 110. In some examples, the controller 106 may compare the analog reference signal 2702 to the measurements 2710 wherein differences between the analog reference signal 2702 and the measurements 2710 may be an error. The controller 106 may then generate signals for the power stage 104 to reduce the error.

Additional reference is made to FIG. 28, which illustrates an example of the system 100 of FIG. 27 with the analog circuitry 2704 replaced with an analog-to-digital converter (ADC) 2804. The ADC 2804 may operate at a speed wherein it is able to digitize the highest frequency components in the analog reference signal 2702. In the embodiment of FIG. 28, the controller 106 may receive the analog reference signal 2702 in a digital format. Accordingly, the measurements 2710 may also be in a digital format, so the controller 106 may process the differences between the analog reference signal 2702 and the measurements 2710 digitally. The signals transmitted by the controller 106 to the power stage 104 may be in the same format as described with reference to FIG. 27.

Reference is made to FIGS. 29A-29D, which illustrate example waveforms (e.g., V_{SYS}) that may be generated by the embodiments of the system 100 of FIGS. 27 and 28. The system 100 may be tuned for fast response time operation, meaning that the system 100 may generate an output signal V_{SYS} having frequency components that include the highest frequency components of the analog reference signal 2702. In other embodiments, the system 100 may generate an output signal V_{SYS} having frequency components that are about as high as the highest frequency component of the analog reference signal 2702. In at least some of the examples of FIGS. 29A-D and other examples disclosed herein, the inversion stages 204 of the DC-DC converter cells 110 may be based on push-pull Class E designs to achieve the bandwidth necessary to generate the output waveforms, owing to their ability to switch their internal devices efficiently at relatively higher switching frequencies compared to other implementations.

In some examples, the analog reference signal 2702 may be an analog signal having a DC component superimposed with an AC component of a desired waveform. In some examples, the analog reference signal 2702 may have voltage levels between 0 and 4V, wherein the controller 106 may be configured to receive voltages in this range.

Additional reference is made to FIG. 30, which illustrates another embodiment of the system 100 wherein rather than having the analog reference signal 2702 input to the system 100, a reference signal may have pre-stored signal parameters 3002 in a memory device. In some examples, the memory device may be implemented within the controller 106. Examples of the pre-stored signal parameters 3002 may include aspects such as period, duty cycle, shape of the waveform, peak-to-peak voltage, current, and DC offset, among other possible other parameters. The controller 106 may be configured to receive data indicative of the pre-stored signal parameters 3002 and generate signals (e.g., signals G1 and G2—FIG. 2) to control the power stage 104 in response to the pre-stored signal parameters 3002.

In some embodiments, the signal parameters 3002 may include parameters of a plurality of signals to be output by the system 100. For example, a first pre-stored set of signal parameters may be used to drive a first load or first type of load and a second set of pre-stored signal parameters may be used to drive a second load or a second type of load. A user or other controller may instruct the system 100 to generate an output V_{SYS} based on specific pre-stored signal parameters. For examples, certain pre-stored parameters may be selected depending on the load or drive requirements into the load 136. In another example, when the system 100 is configured to drive a semiconductor fabricating device, the pre-stored signal parameters 3002 may output first parameters during a start up of the fabrication process. After a predetermined period, the pre-stored signal parameters 3002 may output second parameters during another stage of the fabrication (See FIG. 32A for example). In other examples, the pre-stored signal parameters 3002 may reflect possible or predetermined changes in the load. For example, and as described herein, impedances of the load may change over time. The pre-stored signal parameters 3002 may output parameters that reflect the changes in impedances.

Having described embodiments of the controller 106, alternate embodiments of the power stage 104 will now be described. Reference is made to FIG. 31, which illustrates another embodiment of the system 100 including an alternate embodiment of the power stage 104.

In some embodiments, the system 100 of FIG. 31 may include a series-based modular multilevel converter comprising a plurality of isolated DC-DC converter cells 110 configured as open loop DC voltage sources. The DC-DC converter cells 110 may have outputs selectively configured for aggregating respective output voltages. The aggregated output voltages of the DC-DC converter cells 110 may be shaped by selectively switching the outputs between fixed levels and by filtering the multilevel stepped waveform using an output filter 3114. For example, the waveform generated by switching the DC-DC converter cells 110 may have voltage steps or ripples resulting from switching individual ones of the switching stages 140. The output filter 3114 may filter the waveform generated by the output switching stages 140 to remove the frequency components constituting the steps and/or ripple to generate a clean output voltage V_{SYS} without the ripple frequency components.

In other embodiments, the system 100 of FIG. 31 may include multiple stages of a bidirectional converter used in combination with output chopper circuitry having inputs coupled in parallel and outputs coupled in series to provide efficient and high bandwidth control. In such embodiments, the system 100 may provide efficient high bandwidth waveform generation with passive switch utilization by using open loop DC-DC converter cells 110 and multi-level interleaved switching, wherein multiple switching stages 140 are controlled to operate in parallel but with a phase shift between the stages such that the total combination of voltages V_{CELL} achieve a desired waveform. The waveform generated by switching the DC-DC converter cells 110 may have voltage steps or ripples resulting from switching individual ones of the switching stages 140. In a PWM controller, the control output can be updated at up to the effective switching frequency, which is the number of different phases times the nominal switching frequency of each phase (standard interleaving effect). As an example, with an example implementation of 4 phases at 100 kHz, the update rate is 400 kHz; every 2.5 us the output switches to the higher voltage switch configuration from the controller 106, runs for the set duty cycle, then switches to the lower voltage configuration.

In some embodiments of the system 100, the switching frequency of the DC-DC converter cells 110 may depend on whether a short circuit is used across an the output of a DC-DC converter cell, the speed of circuits (e.g., the circuit 200—FIG. 2) used to implement the DC-DC converter cells 110, feedback circuitry, and specifications of the load 136. The switching frequency may, in some embodiments, be from tens of kilohertz to one megahertz. In other embodiments, the switching frequency may be from hundreds of kilohertz to one megahertz. In yet other embodiments, the switching frequency may be one megahertz and/or higher.

Embodiments of a multilevel bidirectional high-voltage waveshaper according to the system 100 of FIG. 1, may be an implementation and/or derivative of the series cell design of FIG. 1, but which is different in operation and control schemes. In the embodiment of FIG. 31, the isolated DC-DC converter cells 110 may be configured as open loop DC voltage sources. The DC-DC converter cells 110 may shape the output waveform by switching the outputs of the DC-DC converter cells 110 between fixed levels then filtering the multilevel stepped waveform. In some embodiments, the DC-DC converter cells 110 may be buck derived and easy to model and control relative to the frequency and enable response of resonant DC-DC converters. Compared to an MMC, the filter and control design may be configured for high control bandwidth. This configuration may include a high order or dampened output filter 3114 and some amount of bus voltage and filter modelling for feedforward operation. A secondary function of the output filter 3114 may be to limit and/or shape the load on switches (e.g., switches in the switching stages 140) and set open loop output impedance.

The power stage 104 may have easily modelled output voltage V_{SYS} and impedance. Therefore, in some embodiments, the output V_{SYS} can be predetermined instead of requiring real time control. For these configurations, the drive signals (e.g., G1 and G2—FIG. 2) can be calculated in advance with slower compensation of operating conditions such as input voltage by feedforward control or closed loop control. These configurations may also enable higher bandwidth and/or lower switching ripple on the output waveforms with a higher order and longer delay in the output filter 3114. The configuration may further enable output measurements 3120 with higher latency pipelined, folding, etc. ADCs, may be used in feedforward configurations, such as when an input voltage is sampled and processed via a digital controller implementing feedforward control.

Some advantages of the system 100 of FIG. 31 may include isolated DC-DC converter cells 110, which can be configured as low bandwidth converters at high efficiency and component utilization operating points instead of facing tradeoffs for speed or control. This configuration may enable lower cost, higher efficiency, and lower isolation capacitance in the DC-DC converter cells 110 of FIG. 31. The system 100 may enable bidirectional power transfer for two or four quadrant power supplies and more efficient output discharge and/or AC signal generation. High peak power may be available with just switches (e.g., switching stages 140) and DC rails in the output path rather than relying on output impedances and transient responses of the DC-DC converter cells 110.

As shown in FIG. 31, a variation of the described topology of FIG. 1 may implement the isolated DC-DC converter cells 110 as low bandwidth bidirectional converters and may remove cell and stack enable controls. Instead, the output V_{SYS} may be controlled entirely by the output switching stage 140 and the output filter 3114. This configuration may constrain the control options of the system 100 and may provide some advantages relative to the configuration of FIG. 1. For example, the configuration of FIG. 31 may have faster rise times and regulation requirements that do not constrain the design of the isolated DC-DC converter cells 110. The DC-DC converter cells 110 can then be optimized for isolation, efficiency, and/or power density.

The configuration of FIG. 31 may be adaptable to bidirectional operation, which enables power sinking for applications such as high voltage loads and capacitor discharge.

The output switching stage 140 may be more convenient to implement than an enable/disable configuration because it may be buck derived. The buck derived configuration may be easier to model and control versus the frequency and enable response of resonant converters. Furthermore, by using pulse width modulation (PWM) for the switching stage 140, there may not be discontinuities from the discrete enable control. In some embodiments, outputs of the isolated DC-DC converter cells 110 can be bypassed with substantial capacitance, which may enable higher peak power limited by the bypassing, switching stage, and filter in the output path rather than the high frequency output impedance of an isolated conversion stage. The isolated conversion may have high parasitic impedances introduced by a large isolation gap and a low output capacitance that may be needed to achieve fast rise times. This, and the bidirectional ability of the power stage 104 (depending on frequency), may enable more efficient driving of reactive loads. Some embodiments of the system 100 may use optical links between the controller 106 and the power stage 104 for low jitter and propagation delay variation gate drive signaling.

The same configurations of converter and transformer design, high speed control, and load characteristics described herein may be applicable to the configuration of FIG. 31. Depending on the application, the output V_{SYS} can be predetermined instead of requiring real time control. For these conditions, drive signals (e.g., G1 and G2—FIG. 2) can be calculated in advance with slower compensation of operating conditions, such as input voltage, by feedforward or closed loop control. This configuration may enable higher bandwidth and/or lower switching ripple output waveforms with a higher order and longer delay output filter 3114. The configuration may also enable output measurements 3120 with higher latency pipelined, folding, etc.

Some design characteristics of the isolated DC-DC converter cells 110 of FIG. 31 may include a unity gain capacitor-inductor-inductor-capacitor (CLLC) topology which may accommodate large leakage inductance and low magnetizing inductance of transformers (e.g., transformer T1—FIG. 2) for open loop, unregulated operation and/or passive bidirectional power flow. This configuration may achieve zero voltage switching (ZVS) on all switches in the switching stages 140 and/or zero current crossing (ZCS) on rectifying sides of the circuit 200 (FIG. 2) and near ZCS on the inversion stage 204 with >97-98% efficiency depending on more specific design parameters.

In some embodiments, the switching stages 140 may be implemented as output bridges. The output bridge designs may be flexible depending on the application, wherein depending on the power flow and switching requirements, full bridge (four quadrant), half bridge (two quadrant) or switch with a diode (one quadrant) may be implemented. There may be a cost and efficiency tradeoff by additional switches in the system 100, so not every application will justify a full bridge. For example, high peak output power applications may benefit from higher saturation currents of SiC, depletion mode GaN, or gate injection transistors, whereas high bandwidth applications may use enhancement mode GaN for efficient switching characteristics and ease of gate drive. The switching stages 140 may be controlled to operate in parallel but with a phase shift between the stages to achieve low output ripple, a small and efficient output filter, and high control bandwidth.

The output filter 3114 may sum the bridge output voltages and shape the frequency content of that signal to produce the desired output voltage V_{SYS}. Its small signal bandwidth may depend on filtering, which may need to attenuate the switching ripple as described herein. The switching ripple may have a frequency of a base output switching frequency times the number of effective switching phases. A higher order filter can provide less margin between the switching ripple and the output bandwidth for specific attenuation requirements. Large signal response may be limited by the effective switching frequency for continuous waveforms.

Configuration of the controller 106 may depend on the rest of the system requirements. The output may be buck derived, so compensation may be straightforward depending on the output filter 3114, the load 136, and/or required control bandwidth. Higher output bandwidth may require a high order output filter 3114 and feedforward approach or configuration. Even with a traditional two pole filter (with optional higher frequency filter stages or internal dampening), feedback and processing delays can introduce unmanageable phase shifts for pure feedback-based control of the required switching speed. The compensation or feedforward output may be a duty cycle or voltage setpoint, which may later be written to the power stage 104 as switching states. For example, if the controller 106 commands a 55% effective duty cycle, the controller may program the power stage to switch four switches as follows: 50% (e.g., 1,1,0,0) for 80% of the time and 75% (e.g., 1,1,1,0) for 20% of the time. For the voltage control option, the same may apply except the switched voltages may be used instead. For example, commanding 880V, the controller 106 may have the following: 800V (e.g. 400, 400, 0, 0) for 80% of the time and 1200V (e.g. 400, 400, 400, 0) for 20% of the time. In another example, the controller 106 may command: 600V (300, 300, 0, 0) for ˜6.7% of the time and 900V (300, 300, 300, 0) for ˜93.3% of the time. The voltage control implementation may use input voltage feedforward so the controller 106 may not need to fully compensate for the DC input and rail voltages.

In some embodiments, the actual switching frequency may need to be higher for output waveforms with larger AC components. The switching signals may then be implemented as pulse width modulated (PWM) signals to the power stage 104 to produce duty cycles set by the controller 106. The duty cycles may also simultaneously balance phase to phase loading and/or switching losses by selection of different redundant states. The design of the feedforward configuration can include isolated rail voltages if measured or modeled from converter input and output, which may be advantageous depending on the output impedance of the isolated designs of the DC-DC converter cells 110.

As a further example, each isolated DC output may be nominally at the same voltage, and the sum of all the DC outputs x switch states produces the output voltage V_{SYS}. There may be redundant configurations as long as not all the switches are in the same state. For example with four 400V cells to achieve an 800V output, the states can be, for example: 0, 0, 400, 400; 400, 0, 0, 400; −400, 400, 400, 400 (with a full bridge output switch), etc. In order to match the switching losses or DC power drawn from each isolated DC rail, the controller 106 can select between the different states. For example, if the controller 106 knows that a first DC-DC converter cell is hotter or has had higher switching losses already, the controller 106 can preferentially assign switching transitions to the other three DC-DC converter cells to reduce the stress on the first one.

The above description of the embodiment of FIG. 31 has been applied to a single stack of DC-DC converter cells 110 and switching stages 140 coupled in series. Scaling with additional stacks coupled in parallel may be implemented in some embodiments. The additional stacks may add additional control complexity for current balancing between the stacks for constant voltage regulation. The implementation with additional stacks may include a lower frequency control loop to actively control the output current per stack such that the loading is substantially evenly distributed across the stacks for a given system output voltage V_{SYS}. For example, one means of doing so is to adjust volt-seconds applied by each stack to its respective output filter 3114, thereby adjusting the current balance between stacks, or an equivalent approach.

High bandwidth output measurements may not be required for feedforward approaches. In some closed loop embodiments, metrology requirements, and fault detection implementations may include output sample rates upwards of one million samples per second and sub microsecond delays or additional circuitry for fault monitoring. Measurements may also include measuring voltages before the output filter 3114, which can indicate the operating conditions of the DC-DC converter cells 110 with less delay and higher accuracy. These measurements may be transmitted to the controller 106 over an isolated data link or parts of the controller may be galvanically connected to the output measurements 3120 depending on system requirements.

The different embodiments of the system 100 described herein may provide customized high-voltage wave shaping from the power stage 104. In some embodiments, the wave of the output voltage V_{SYS} may be used in to control ion energy distribution for semiconductor etch and deposition processes. For example, the wave of the output voltage V_{SYS} may form a narrow and well-controlled ion energy distribution, which can also be advantageous across thin film plasma-related applications.

Additional reference is made to FIGS. 32A-C which illustrate examples of waveforms that may be supplied by the system 100 during semiconductor fabrication, including etching silicon substrates (wafers). FIG. 32C illustrates an embodiment of a voltage waveform or potential on a semiconductor wafer during semiconductor fabrication in response to the voltage V_{SYS} of FIG. 32A. The current of FIG. 32B is an example of current that may be output from the system 100 and applied to the substrate. The waveform of FIG. 32A may rise from a negative potential to a positive potential and maintains the positive potential for a first period. The waveform may then decrease in potential to a first negative potential for a second period, the second period having a first predetermined negative slope, the waveform may then continue to decrease in potential for a third period with a third slope, the third slope being less than the first slope. The architecture of the system 100 described herein may be scalable across different voltages and power levels and therefore lends itself to substrates with larger (or smaller) sizes, and higher voltages.

In addition to the previous applications, the output V_{SYS} from the system 100 may be used on applications including solar wafer manufacture (e.g., solar PV), glass applications (e.g., amorphous silicon/CIGS/CdTe for solar PV, flat panel displays, optical/filter coatings), textile manufacturing (e.g., hydrophilic and hydrophobic treatments), and roll-to-roll substrates, such as plastic coatings, metal coatings, and thin-film batteries.

The output V_{SYS} may also be used in cardiac ablation and related pulsed electric field ablation applications may also benefit from tailored waveforms produced by the system 100, where the efficiency of ablation and patient safety can be improved by feedback-controlled waveforms. Medical plasma devices, such as cold-plasma generators for wound healing and sterilization, may use the output V_{SYS}, either as a finely controlled DC source or as a repetitively pulsed plasma generator.

The output V_{SYS} may be used in pulsed electric field (PEF) processes across industries, including pasteurization of milk, juice and other liquids, treatment of agricultural products, such as potatoes, and for extraction processes. System-directed example aspects of the present disclosure may improve these processes by generating high fields and high powers at cost-effective levels and by being able to fine tune the rise and fall times and the pulse widths of the output V_{SYS}. This can also improve the processes by utilizing non-square waveforms that may optimize the applied field to improve cell destruction (in the case of microbial treatments or food processing) or for maintaining similar end results (pasteurization, extraction, etc.) with less damage to the nutrient quality or texture of the treated substance.

The output V_{SYS} may be used with nanosecond repetitively pulsed (NRP) plasma generation utilizing high-voltage (>1 kV, often >10 kV) pulses with nanosecond-scale rise and fall times and pulse widths. The high-voltage architecture and control techniques of the system 100 can be utilized as a high-end nanosecond pulse generator. Unlike existing products, this type of generator may be used to vary the pulse magnitude (peak voltage), rise time, fall time, pulse width, and pulse shape on a pulse-by-pulse time scale (pulse-by-pulse referring to the pulses in the signal that are output by the system 100). By varying one or more of these control parameters, the generation and control of the plasma can be enhanced. In some embodiments, the waveshapes of the pulses in the output signal may be varied from one cycle or from one pulse to the next, for example, until monitoring circuitry (e.g., in the controller 106) realizes a certain outcome as indicated by operation of the load 136 and/or each of the DC-DC converter cells 110 and/or the aggregate signal of a combined set of DC-DC converter cells 110.

As another example, the output V_{SYS} may include a few high-voltage pulses that may be used to ignite glow plasma, followed by a series of pulses at lower voltage to sustain the plasma. This waveform of the output V_{SYS} may also be repeated in burst mode to keep the overall heating of the gas minimal while maintaining a high-plasma intensity. Applications of NRP plasmas that could benefit from the output V_{SYS} include cold plasma for medical applications (sterilization, improvement to wound healing, cancer treatment, etc.), air, gas and water abatement systems, biofuel generation, methane pyrolysis, nitrogen fertilizer generation, PFAS (per- and polyfluoroalkyl substances) degradation and abatement, lean combustion (plasma assisted combustion), improved ignition (e.g., spark-plug replacement) for internal combustion engines, exhaust treatment for diesel and gas engines, pretreatment of gas for internal combustion engines, and various types of surface treatments, such increasing the hydrophilic or hydrophobic nature of a surface, priming for paint, or cleaning of residue.

In connection with certain of the specific examples of the present disclosure, the above-characterized figures and discussion are provided to help illustrate certain aspects (and advantages in some instances) which may be used in the manufacture of such structures and devices. For example, the flow diagrams of FIGS. 6, 9, 10, 11, and 12 are presented to exemplify methods and/or uses according to specific approaches involving operations of the system 100 of FIG. 1 (e.g., with each flow diagram depicting one or more blocks which may be used alone or in combination with other aspects depicted blocks in the flow diagram). As may be useful in certain implementations, such structures and devices may include the example structures and devices described in connection with one or more related aspects (e.g., by modifying and/or combining with the examples of the present disclosure).

The specification may describe and/or illustrate aspects useful for implementing the examples by way of various semiconductor materials/circuits which may be illustrated as or using terms which refer to circuits such as block, module, stack, device, system, unit, stage, controller, and/or other circuit-type depictions. Also, in connection with such descriptions, where appropriate in certain circuit polarity orientations the term “source” may refer to source and/or drain interchangeably in the case of a transistor structure. Such semiconductors, semiconductive materials (including portions of semiconductor structure), circuit elements and/or related circuitry may be used together with other aspects of the present disclosure to illustrate how certain examples may be carried out in the form or structures, steps, functions, operations, activities, etc. It is also noted that terms to illustrate orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, such terms should not be construed in a limiting manner.

What is claimed:

1. A system for generating customized waveforms, the system comprising:
a plurality of DC-DC converter cells coupled in series to form a stack; and
a controller to generate control signals to drive the DC-DC converter cells in the stack to generate a customized waveform at a node, the controller comprising a lookup table to store at least one characteristic affecting the customized waveform, wherein the control signals to each of the plurality of DC-DC converter cells are based at least in part on the at least one characteristic.

2. The system of claim 1, wherein the at least one characteristic includes resistance of a load.

3. The system of claim 1, wherein the at least one characteristic is impedance of a load.

4. The system of claim 1, wherein the at least one characteristic is at least one condition of a load.

5. The system of claim 1, wherein the controller comprises an input configured to receive an input signal, and wherein the controller is configured to generate the control signal, at least partially, in response to the input signal.

6. The system of claim 1, wherein the controller is configured to generate signals to cause the stack to amplify an input signal.

7. The system of claim 1, wherein the controller further comprises a filter configured to filter frequency components in the customized waveform resulting from switching of one or more of the plurality of DC-DC converter cells.

8. The system of claim 1, further comprising a second stack comprising a plurality of DC-DC converter cells coupled in series, wherein the second stack is coupled to an output, and wherein the controller is further configured to couple the plurality of DC-DC converter cells of the second stack to the node.

9. The system of claim 1, wherein the system is configured to generate a customized waveform, the customized waveform comprises a peak voltage that changes by a voltage step before a ramped voltage.

10. The system of claim 1, wherein the plurality of DC-DC converter cells are isolated from one another, and wherein a voltage of a first DC-DC converter cell output may be aggregated to the voltage of a second DC-DC converter cell.

11. A system for generating customized waveforms, the system comprising:
a plurality of DC-DC converter cells coupled in series, each of the plurality of DC-DC converter cells comprising a cell output, voltages of the cell outputs being settable to predetermined voltages;
a plurality of switches, each of the plurality of switches having an input, and inputs of a individual switches coupled to individual cell outputs, the plurality of DC-DC converter cells and plurality of switches forming a stack;
a controller configured to generate control signals to switch on individual ones of the switches to couple individual ones of the DC-DC converter cells in series to generate a waveform; and
a filter coupled between the stack and an output, the filter configured to shape the waveform to the customized waveform at the output.

12. The system of claim 11, wherein at least one of the plurality of switches comprises a half bridge.

13. The system of claim 11, wherein at least one of the plurality of switches comprises a full bridge.

14. The system of claim 11, wherein at least one of the plurality of switches comprise a diode and a switch configuration.

15. The system of claim 11, wherein the controller generates control signals to turn individual ones of the switches on and off and wherein the waveform is generated at least partially by frequencies of the control signals to individual ones of the switches.

16. The system of claim 11, wherein the controller generates control signals to turn individual ones of the switches on and off and wherein the waveform is generated at least partially by pulse widths of the control signals to individual ones of the switches, wherein on times of the individual switches are functions of the pulse widths.

17. The system of claim 11, wherein the filter is configured to filter frequency components from the waveform resulting from one or more of the switches turning on or off.

18. The system of claim 11, wherein the system is configured to generate a customized waveform that changes from a peak potential to a first negative potential before the waveform is a ramped voltage.

19. A method of generating customized waveforms, the method comprising:
receiving an input signal representing a customized waveform to be generated;
providing a plurality of DC-DC converter cells coupled in series to form a stack, outputs voltages of individual ones of the plurality of DC-DC converter cells being responsive to control signals received at individual ones of the plurality of DC-DC converters; and
generating the control signals to drive individual ones of the DC-DC converters in the stack to generate the customized waveform at the output, the generating comprising referencing a lookup table configured to store at least one characteristic affecting the customized waveform, wherein the control signals to each of the plurality of DC-DC converter cells are generated at least in part based on the at least one characteristic.

20. The method of claim 19, wherein generating comprises generating control signals to output a waveform that changes from a negative potential toward a positive potential, the waveform then changes in potential to a first negative potential before changing in potential along a negative voltage ramp.
